(19) United States
(12) Patent Application Publication
(10) Pub. No.: US 2012/0116829 A1
(43) Pub. Date: May 10, 2012

(54) OPERATIONS MANAGEMENT METHOD

(76) Inventors: Puay Siew Tan, Singapore (SG); Yan Guan Roland Lim, Singapore (SG); Niak Wu Koh, Singapore (SG)

(21) Appl. No.: 13/224,282

(22) Filed: Sep. 1, 2011

(30) Foreign Application Priority Data
Sep. 3, 2010 (SG) 201006436-8

(51) Int. Cl. G06Q 10/06

(52) U.S. Cl. 705/7.14; 705/7.27

(57) ABSTRACT

An operations management method 1000 is disclosed herein and in one embodiment, the method 1000 includes at Stage 1 determining at least one competitive gap of the business and identifying at least one business objective to address the at least one competitive gap. At Stage 2, the method 1000 includes identifying at least one functional group for meeting the at least one business objective and generating an activity diagram to define work process of the business based on the at least one functional group. At Stage 3, the method 1000 includes identifying at least one improvement area based on the generated activity diagram and calculating current productivity of activities being performed at the at least one improvement area. At Stage 4, the method 1000 includes identifying an initiative to improve the at least one improvement area and which is expected to achieve a better productivity.

### BACKGROUND AND FIELD

This invention relates to an operations management method for a business

From a productivity angle, a typical measure of productivity is in this form:

$$Productivity = \frac{Output}{Input}$$

In such measures, productivity is measured in terms of efficiency only, i.e. how well activities of a process (or company) transform resources (inputs) into output. This transformation process is a value-add of the activities to the inputs. Such measure does not consider whether a company is producing the correct output in the first place and thus, it is difficult to determine the effectiveness of the activities in fulfilling the company's competitive strategy. Some research work attempted to define productivity as a function of these two aspects: effectiveness and efficiency. However, these works failed to provide a good mechanism to link and quantify these two aspects, and how it can be used to measure productivity more holistically, as in how they value-add to a company's activities that are aligned to its strategic intent. This is an important aspect that must be addressed. For example, it has been stated that the essence of all competitiveness and productivity concepts is the relationship between output and input. Yet most discussions of these concepts tend to concentrate on the way in which inputs are identified and classified. Thus, typical prescriptions for becoming more productive involve ‘cutting costs’, or ‘reducing the number of employees’. While this concentration on inputs is understandable, it is too narrow.

Furthermore, currently, it is not possible to compare productivity indices across different functional areas of work. For example, in measuring labour productivity on a factory floor, it could be stated as $20.00 per part or 5 man-hour per part. In measuring non-direct productivity, it could be stated as 5 hour per Purchase Order (PO) or 2 man-hour per PO also. Thus, it is difficult to know the company's overall productivity.

To address this, it has been proposed to map all productivity indices into a common scale, i.e. monetary value that is easily understood. The concept of partial productivity measures (e.g. labour, equipment and material) and total productivity measure was also proposed. However, it focused on the efficiency aspect only. Also, in calculating the productivity indices, it was assumed that the current value of inputs and outputs are equivalent across different time periods (current and future). This is not valid for all cases, and there is a need to take into account differing cost and price environments across different periods of measure.

In reality, companies may be able to identify broad issues and perhaps attempt to use new initiatives to address these issues to raise productivity. However, they may not have a systematic way of identifying these issues and in any case, the initiatives often fail to deliver expected end results.

It is an object of the present application to provide an operations management method which addresses the disadvantages of at least one of the prior art and/or to provide the public with a useful choice.

### SUMMARY

In a first aspect, there is provided an operations management method for a business comprising
(i) determining at least one competitive gap of the business from a performance review of the business;
(ii) identifying at least one business objective to address the at least one competitive gap;
(iii) identifying at least one functional group for meeting the at least one business objective;
(iv) generating an activity diagram to define work process of the business based on the at least one functional group;
(v) identifying at least one improvement area based on the generated activity diagram and in relation to the at least one business objective;
(vi) calculating current productivity of activities being performed at the at least one improvement area;
(vii) identifying an initiative to improve the at least one improvement area and which is expected to achieve a better productivity than the calculated current productivity.

With such a method, each of the activities is inter-related which is important so that any action or initiative implemented is aligned to the business objectives. Further, such a method provides a systematic way for businesses to identify issues, rate the importance of these issues to their strategic intent (alignment to its business objectives) and also estimate how much an identified initiative can improve their operational efficiency of the problem or improvement area.

Preferably. (i) the performance review comprises deriving business background information from analyzing products, customers and competitors of the business. The performance review may further comprise determining a current competitive strategy and a future competitive strategy for the business. In this case, the current and future competitive strategies may be derived based on answers to a same set of questions. The same set of questions may include subsets of questions with each subset of questions being associated with respective business competence of the business.

Advantageously, to determine the current competitive strategy, the method includes assigning a numeral score to each question, and mapping the scores for each question to the associated business competence and adding up the associated scores belonging to the same business competence to derive respective current competitive strategy scores.

In addition or as an alternative, to determine the future competitive strategy, the method may further include assigning a numerical score to each question, and mapping the scores for each question to the associated business competence and adding up the associated scores belong to the same business competence to derive respective future competitive strategy scores.

Preferably, the business competence is selected from the group comprising the business' customer intimacy. operational excellence and product leadership.

The competitive gap at (i) may be identified from the current and future competitive strategies.

At (ii), the method may further include identifying a quantifiable target for the at least one business objective. Preferably, the method further includes identifying a performance measure to determine if the quantifiable target is achieved.

Advantageously, the method further comprises defining or analysing the business organizational structure. This will help to alignment the organization structure to support the at least one business objective or competitive strategy. The at least one functional group may be identified from the organization structure.

Preferably, the activity diagram is generated using Value Stream Mapping (VSM) method. The work process may include information and/or data flow of the business.

The method may further comprise identifying activities, input resources and output of the at least one improvement area. There may be a plurality of improvement areas identified, and the method may thus include calculating current productivity of activities being performed at each of the improvement areas. Each improvement area may be associated with a respective initiative, and (vii) further comprises calculating expected productivity of each improvement area based on the associated initiative. The method may further include calculating productivity impact of each improvement area from comparison between respective expected productivity and the current productivity.

Each improvement area and associated initiative may be ranked and based on the calculated productivity impact.

The current productivity and expected productivity may be selected from the group consisting of labour productivity, material productivity, energy productivity, capital productivity.

Advantageously, the method may further comprise developing an action plan to implement the initiative. The method may also comprise assigning the initiative to a responsible person for implementing the initiative and allocating a budget for implementing the initiative. It is preferred to set a duration for completing the initiative. Preferably, the method may further comprise assigning a quantifiable target to be achieved by implementing the initiative, the quantifiable target being aligned to the at least one business objective.

### BRIEF DESCRIPTION OF THE DRAWINGS

An example of the invention will now be described with reference to the accompanying drawings, in which:

FIG. 1 is a flow diagram illustrating an operations management method having stages 1-5 according to a preferred embodiment of this invention;

FIG. 2 is a diagram illustrating productivity as a function of effectiveness and efficiency;

FIG. 3 is worksheet 1a for representing an overview of Company A's position in a supply chain as part of stage 1 of FIG. 1;

FIG. 4 is worksheet 1b for representing Products, Customers and Competitors of Company A which is also performed at stage 1 of FIG. 1;

FIG. 5 is worksheet 1c(i) comprising a list of questions to determine Company A's current competitive strategy;

FIG. 6 is worksheet 1d comprising Tables 1 and 2 for consolidating scores from worksheet 1c of FIG. 5;

FIG. 7 is worksheet 1c(ii) comprising the same list of questions as FIG. 5 for determining Company A's future competitive strategy;

FIG. 8 is worksheet 1e which consolidates the scores of FIG. 6 as strategy scores;

FIG. 9 is worksheet 1f which is a summary of business competitive gaps identified for Company A;

FIG. 10 is worksheet 1g which is a summary of business competitive gaps and strategy derived from the worksheets of FIGS. 8 and 9;

FIG. 11a and 11b comprise worksheet 1h for recording the competitive gaps and reasons for the gap based on the summary of FIG. 10;

FIG. 12 is worksheet 1i for determining business objectives from the competitive gaps identified in FIG. 11a and 11b;

FIGS. 13a, 13b and 13c are examples of performance measures for competency areas associated with the business objectives of FIG. 12;

FIG. 14 is worksheet 2a illustrating an organization structure for Company A;

FIG. 15 is worksheet 2b for determining relationships between the business objectives defined in FIG. 12 and respective functional groups in the organization structure of FIG. 14;

FIG. 16 is worksheet 2c(i) which illustrates a current activity map of a supply chain for Company A;

FIG. 17 is worksheet 2c(ii) which illustrates the current activity map of FIG. 16 at a functional level;

FIG. 18 is worksheet 2c(iii) which illustrates the current activity map of FIG. 16 at a process level;

FIG. 19 is a table which provides examples of VSM process symbols which may be used in the current activity maps of FIG. 16-18;

FIG. 20 is a table which provides examples of VSM material symbols which may be used in the current activity maps of FIG. 16-18;

FIG. 21 is a table which provides examples of VSM information symbols which may be used in the current activity maps of FIG. 16-18;

FIG. 22 is worksheet 3a which list improvement areas identified from the activity maps of FIG. 16-18 and which are aligned to the business objectives of FIG. 12;

FIG. 23 shows the activity map of FIG. 17 with an improvement area “Business process management” highlighted which is identified in FIG. 22;

FIG. 24 shows the activity map of FIG. 17 with an improvement area “Production process” highlighted which is identified in FIG. 22;

FIG. 25 shows the activity map of FIG. 17 with an improvement area “Project Resource planning and scheduling” highlighted which is identified in FIG. 22;

FIG. 26 shows the organizational structure of FIG. 14 with an improvement area “Sales & Marketing” highlighted which is identified in FIG. 22;

FIG. 27 is worksheet 3b(i) which provides activities, input resources and outputs for the improvement area “Business process management” of FIG. 23;

FIG. 28 is worksheet 3c(i) for calculating current productivity of “Business process management” from the activities, input resources and outputs of FIG. 27;

FIG. 29 is worksheet 3b(ii) which provides activities, input resources and outputs for the improvement area “Production process” of FIG. 24;

FIG. 30 is worksheet 3c(ii) for calculating current productivity of “Production process” from the activities, input resources and outputs of FIG. 29;

FIG. 31 is worksheet 3b(iii) which provides activities, input resources and outputs for the improvement area “Project planning and scheduling” of FIG. 25;

FIG. 32 is worksheet 3c(iii) for calculating current productivity of “Project planning and scheduling” from the activities, input resources and outputs of FIG. 31;

FIG. 33 is worksheet 3b(iv) which provides activities, input resources and outputs for the improvement area “Sales and marketing” of FIG. 26;

FIG. 34 is worksheet 3c(iv) for calculating current productivity of “Sales and marketing” from the activities, input resources and outputs of FIG. 33;

FIG. 35 is a table which provides examples of additional productivity measures which may be used in the calculation of productivity of improvement areas;

FIGS. 36a and 36b are examples of initiatives which may be used when identifying initiatives to address the improvement areas of FIG. 22;

FIG. 37 is worksheet 4a for recording initiatives identified to address the improvement areas of FIG. 22;

FIG. 38 is worksheet 4b for comparing future productivity and the current productivity of FIGS. 28, 30, 32 and 34;

FIG. 39 is worksheet 4c for prioritizing the improvement areas based on productivity impact from the comparison of the future and current productivity of FIG. 38;

FIG. 40 is worksheet 5a for assignment responsibilities and estimating budgets for the initiatives of FIG. 39; and

FIG. 41 is worksheet 5b for establishing duration and deliverables for the initiatives of FIG. 40.

### DETAILED DESCRIPTION OF PREFERRED EMBODIMENT

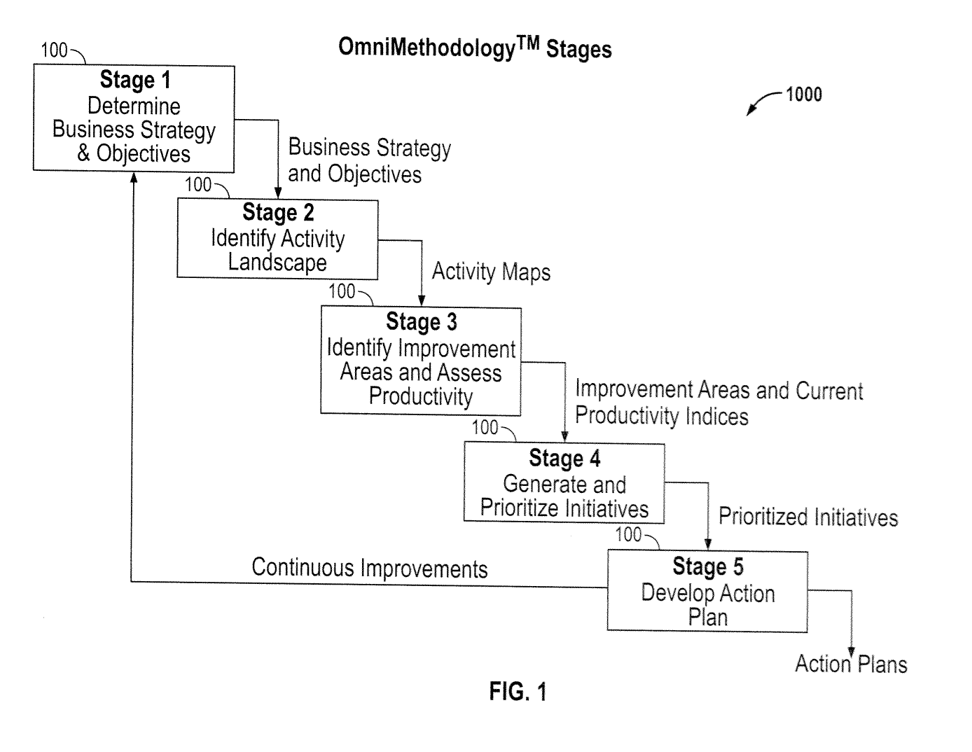

FIG. 1 is a flow diagram illustrating an operations management method 1000 which includes five stages 100,200,300,400,500. The operations management method 1000 may also be referred to as Operations Management Innovation OmniMethodology™. The method 1000 is designed with steps/activities at each stage, with the preceding stage producing an output that flows into the next stage or subsequent stages.

These five stages 100,200,300,400,500 are explained further below:

Stage 1 (100): Determine Business Objectives

Input: Experience and knowledge of company

Output: Business objectives

Objectives of this stage are to help companies identify their competitive strategy and/or gaps with their desired future state (competitive strategy) of the company. To achieve this, knowledge and experience of the company are used and thus a user at stage 1 needs to:
1.1 Understand company background information
1.2 Review current and future business competitive strategy
1.3 Analyse business competitive gaps
1.4 Determine business objectives

In this embodiment, with knowledge of the company background information, the company's business competitive strategy is identified based on a set of thirty questions is one of the main outputs from this stage 100. There are three types of business competitive strategy that have been identified by Treacy and Wiersema (1995), and adapted for use in this method:
Customer Intimacy (CI)
   A company that is focused on creating the best total solution for the customer or client.
   Building long term relationships with the customer, value-add by knowing and understanding the customers' needs very well
Operational Excellence (OE)
   A company that is focused on delivering the best total cost to the customer, typically the lowest cost
   Focused on reducing costs in their operations, and they compete based on cost
Product Leadership (PL)
   A company that is focused on creating the best product for the market (customer)
   Focused on developing high-barrier competitive advantage within the company (typically through R&D)

The other main output is business objectives based on the competitive strategy and/or gaps identified in this stage 100. The business objectives consist of two aspects; performance measures and performance targets which is quantifiable for each identified gap (improvement). Different strategies would have different performance measures. The identified business objectives serve as inputs for the second stage 200.

Stage 2 (200): Identify Activity Landscape

Input: Business objectives

Output: Activity maps

An aim of Stage 2 200 is to produce an unfiltered landscape of activities of the company that are involved in delivering the products and services identified. Activity landscape comprises process for both the material and information flow and is mapped according to the organisation structure and process. The activities here are:
2.1 Understand organization structure of the company
2.2 Check alignment between business objectives and various functional groups of the organisation structure
2.3 Identify current activity map

At this stage 200, the activities for each activity map (which eventually forms the area) can have different levels of granularity. For example, if the operations improvement study is at the shop floor level, it can be a work cell or assembly line. However, if the study is at the enterprise level, then the activity map may be at a department level, an entire shop floor or a sub-section of the production floor (e.g. final assembly). The activity maps (output) are used to identify the inputs needed in activities and output derived from the activities in Stage 3.

Stage 3 (300): identify Improvement Areas and Access Productivity

Input: Business objectives and activity maps

Output: Improvement areas and current productivity indices

As it can be appreciated, the inputs at Stage 3 are the outputs of Stage 1 and Stage 2 and thus, the output of Stage 3 is aligned to at least the business strategy defined at Stage 1.

Aims of Stage 3 are to identify the improvement areas and to assess the current productivity of each of the improvement areas based on the business objectives. The improvement areas comprise groups of activities in the activity maps that have significant impact contributing to the business strategy and objectives. Activities of this stage are:
3.1 Identify improvement areas
3.2 Identify activities, input resources, and outputs of improvement areas
3.3 Assess current productivity of improvement areas

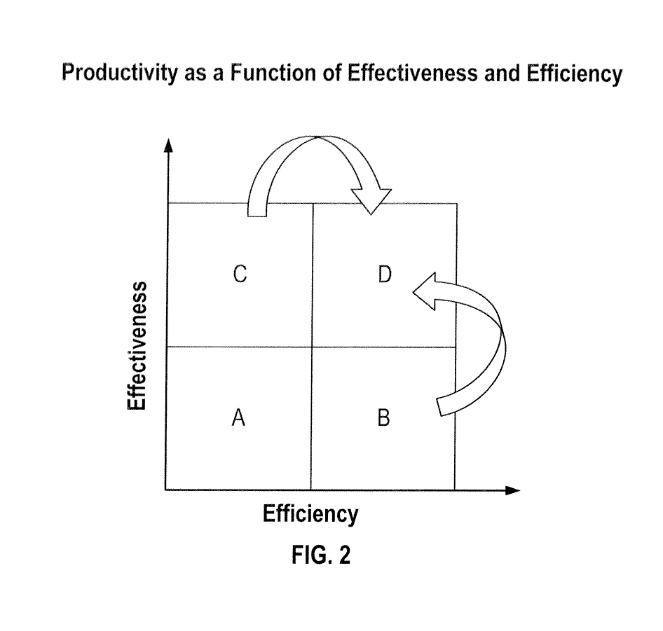

In this stage, improvement areas are identified based on the twin aspects of productivity advocated by this OmniMethodology™ 1000; effectiveness and efficiency. The effectiveness aspect is evaluated through an alignment check of the activities (based on area) with the company's competitive strategy. The efficiency aspect is evaluated through productivity indices calculated based on the activities in the area. This twin consideration is best reflected by the illustration shown in FIG. 2. The main tenet here is to move activities (based on areas) that are in quadrant-C and quadrant-B into quadrant-D, thereby ensuring highly effective and efficient activities for the company.

The productivity indices calculated at Stage 3 include both partial and total productivity measures. The partial productivity measures are labour, material, energy and capital. Each productivity index is calculated using the same basic productivity formulae shown earlier. In this methodology, the calculations are translated into a common scale, in terms of monetary value, enabling a direct comparison between different productivity indices, be it partial or total. The productivity indices here form the “current” productivity (efficiency aspect) of the area. It is important to note that the productivity indices granularity is according to the level of details identified during the activity map creation. As such the indices could be for a work cell, assembly line, an entire production floor, department or even an entire enterprise.

Stage 4 (400): Generate and Prioritise Initiatives

Input: Improvement areas and current productivity indices

Output: Prioritised Initiatives

The outputs of Stage 3 are used as inputs for Stage 4 and the objective of Stage 4 is to develop initiatives based on the improvement areas identified in Stage 3. Following the new initiatives. the “future” productivity of each improvement area is calculated and assessed, and the initiatives prioritized. Activities for Stage 4 are:
4.1 Generate initiatives
4.2 Assess future productivity of improvement areas
4.3 Prioritize initiatives

“Future” productivity indices of each improvement area are calculated in the same way as the “current” productivity indices in Stage 3. However, the data used here are estimations only. in essence, the future productivity indices reflect the potential for productivity gain (or loss) upon the implementation of the identified initiative. Thereafter, a prioritisation of the initiatives is done. There can be many ways to prioritise the initiatives, and one of which is based on the largest productivity gain for a given initiative. Here, a further or more granular prioritization can be done, for example using partial productivity indices instead of total productivity index.

Stage 5 (500): Develop Action Plan

Input: Business Objectives and Prioritised initiatives

Output: Action plan(s)

An aim in this stage is to develop detailed action plans from the list of prioritised initiatives that are aligned to the business objectives. Activities are:
5.1 Assign responsibilities and resources required
5.2 Establish time scale and set clear milestones

The developed action plan(s) are intended to be used by the company as an implementation guide (or roadmap) for the actual realisation of the initiatives. After implementation, the actual productivity can be re-assessed, based on actual data instead of the estimated figures used in Stage 4.

From the above explanation, it can be appreciated that the business objectives (one of the outputs from Stage 1) are subsequently flowed to the later stages of the method 1000 thereby ensuring that any improvements are aligned to the company's strategic intent.

It should also be appreciated that:
The OmniMethodology™ 1000 views operations improvement holistically, using a top down approach, governed by the competitive strategy of the company. In using the company's competitive strategy as a guide towards operations improvement, the OmniMethodology™ 1000 ensures that any improvements are targeted at ensuring that the activities of the company are not only efficient but also effective towards fulfilling the strategic intent.
By viewing productivity as a two factor consideration of effectiveness and efficiency, the OmniMethodoiogy™ ensures that all operations improvement to improve productivity is aligned to the company's strategy.
The OmniMethodology™ is also the first known method that ties three key tenets in a company's activities together; the competitive strategy, the operations and productivity. The OmniMethodology™ provides a mechanism that links and quantifies these three aspects, using means that are easily understood by companies (e.g. strategy type, performance measures such as lead times and a common scale for productivity indices calculation, i.e. monetary values)
The OmniMethodology™ also provides a systematic approach towards operational improvements that can be applied at multi-level and across multi-enterprise.

The OmniMethodology™ as a holistic operations improvement methodology that:
Uses the company's competitive strategy to identify improvement areas
Generate and prioritise initiatives for targeted improvement areas based on productivity gains
Quantification of the two key aspects of productivity; effectiveness and efficiency
   Effectiveness is a measure of activities alignment to the company's competitive strategy
   Efficiency is measured by the typical productivity measure of output/input
Systematic approach for operations improvement that can be applied at multi-level and across multi-enterprise

The method 1000 of FIG. 1 will now be used as an example to improve the business process of company A

Stage 1 (100): Determine Business Objectives

As explained earlier, the aim for Stage 1 is to have an understanding of the business competitive strategy of Company A and to determine the business objectives to be achieved. These are qualified by agreement of the results through an understanding of the company background information, review of the business competitive strategy, analysis of the competitive gaps and identifying business objectives, measures and targets. Each of these sub-stages will now be discussed.

1.1 Understand Background Information

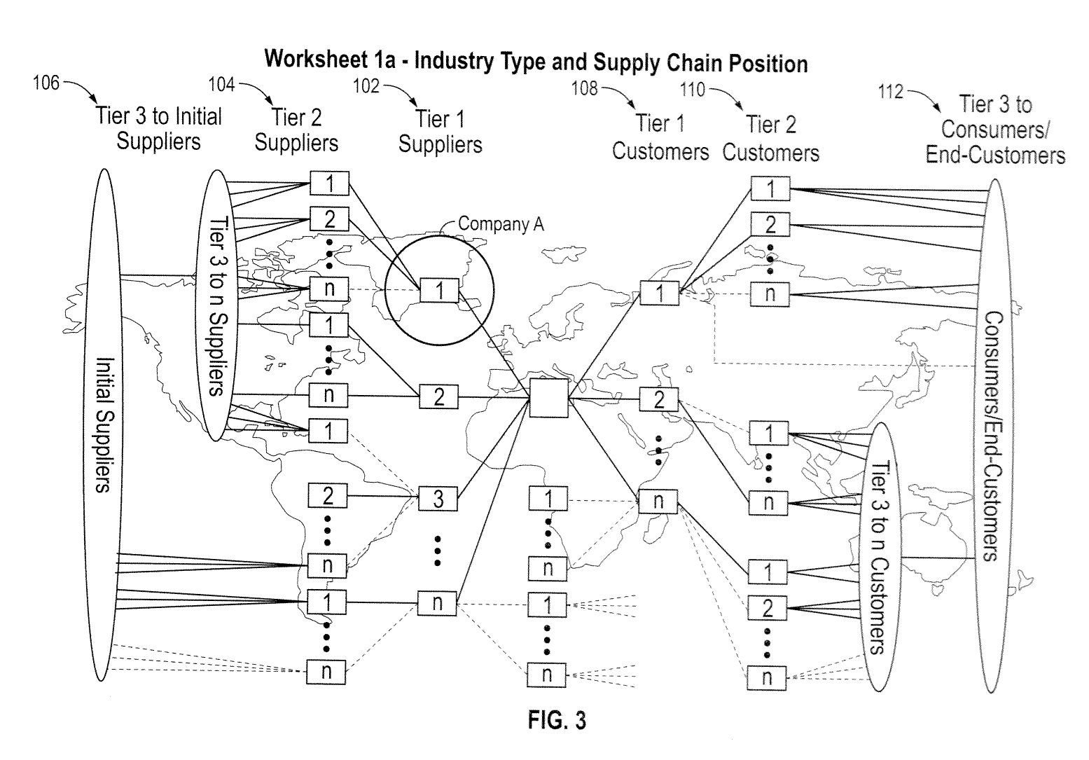

At this initial stage, a representative or representatives of Company A needs to review the experience and knowledge of company A's operations in order to determine the company's position in the overall business environment and industry in which company A operates in. in this embodiment, company A is in the precision engineering (PE) industry and the business environment is a supply chain. in this respect, FIG. 3 is a worksheet 1(a) which illustrates pictorially company A's position in the overall supply chain.

As shown in FIG. 3, there are three tiers of suppliers Tier 1, Tier 2 and Tier 3 suppliers 102,104,106 and company A is identified as among the Tier 1 suppliers to OEM manufacturers who are customers/clients. Correspondingly, FIG. 3 shows that there are three tiers of customers Tier 1, Tier 2 and Tier 3 customers 108,110,112.

As assistance, the representatives may consider the following elements of a supply chain: Customer, MRO (Materials, Repair and Operations), Distribution, Logistics, HO Operations, Manufacturing, R&D, the different supplier and customer tiers etc, to arrive at the worksheet of FIG. 3.

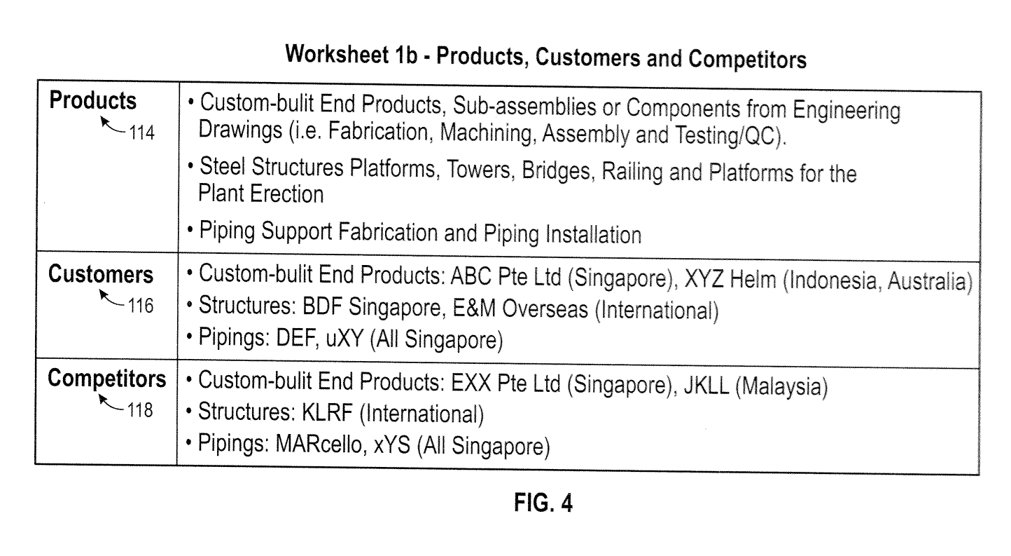

With an understanding of the overview of Company A's operations as illustrated in FIG. 3, the next step is to list products 114, customers 116 and competitors 118 of Company A and these are identified in a worksheet (1b) of FIG. 4. As it can be seen from FIG. 4, the products 114 offered by Company A include custom-built end products etc and the customers 116 might be ABC Pte Ltd etc and the competitors 118 might be EXEC Pte Ltd etc.

In this way, Company A would have an understanding of the company's current supply chain position, the industry type and of the products 114, customers 116 and competitors 118 of the company.

1.2 Review Current and Future Competitive Strategy

This section provides a review of the current and future business competitive strategy of the company. In this embodiment, this strategy uses Customer Intimacy, Operations Excellence and Product Leadership to determine Company A's competitiveness or competence in these three competency areas.

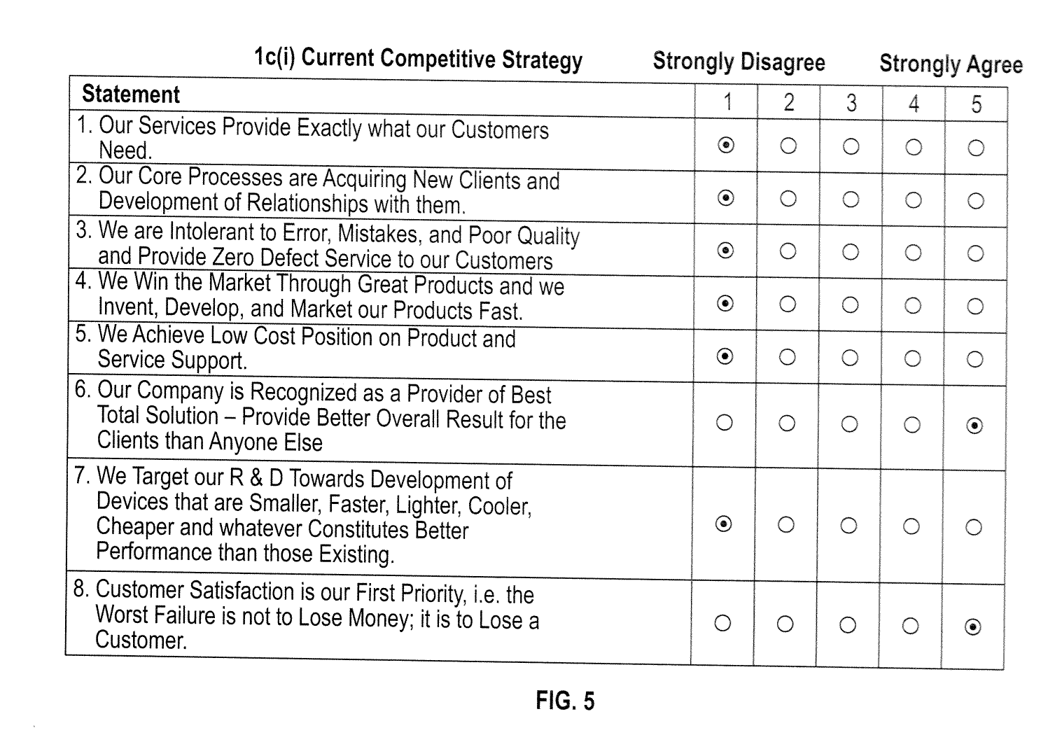

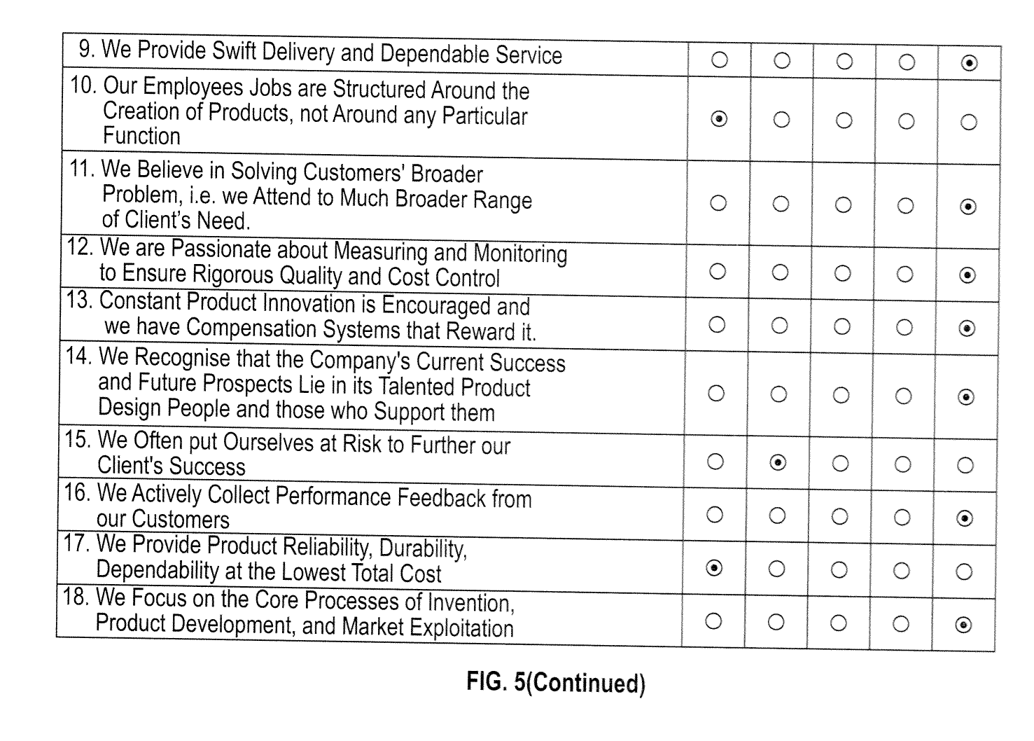

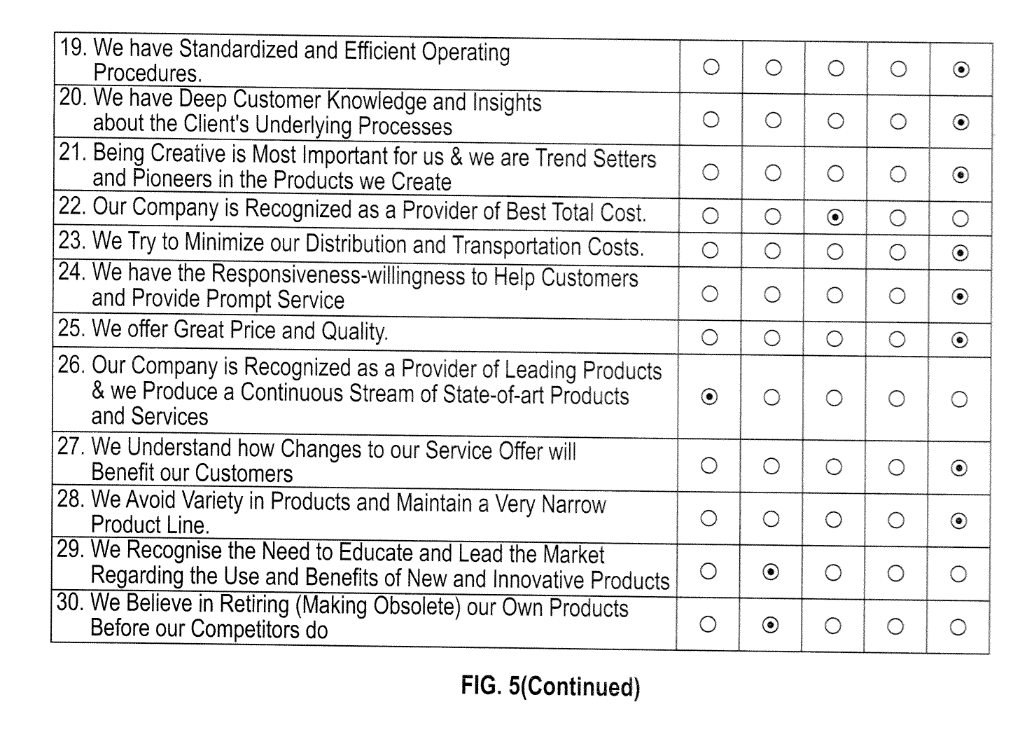

Reviewing the current competitive strategy of Company A takes the form of the representatives of Company A collectively completing worksheet 1c(i) of FIG. 5 which includes a list of thirty questions designed to determine Company A's current competitive strategy in terms of Customer Intimacy, Operations Excellence and Product Leadership which are based on Company A's products 114 and customers 116. For each question, the representatives are to indicate on a scale of 1-5 a number which best represents their view of Company A, with 1 being that they strongly agree and 5 being that they strongly disagree, with the corresponding question. In this embodiment, for question 1 of FIG. 5, the representatives “strongly disagree” that “Our Services provide exactly what our customers need” and in relation to question 17 of FIG. 5, the representatives are of the view that they “strongly disagree” that “We provide product reliability, durability, dependability at the lowest total cost”.

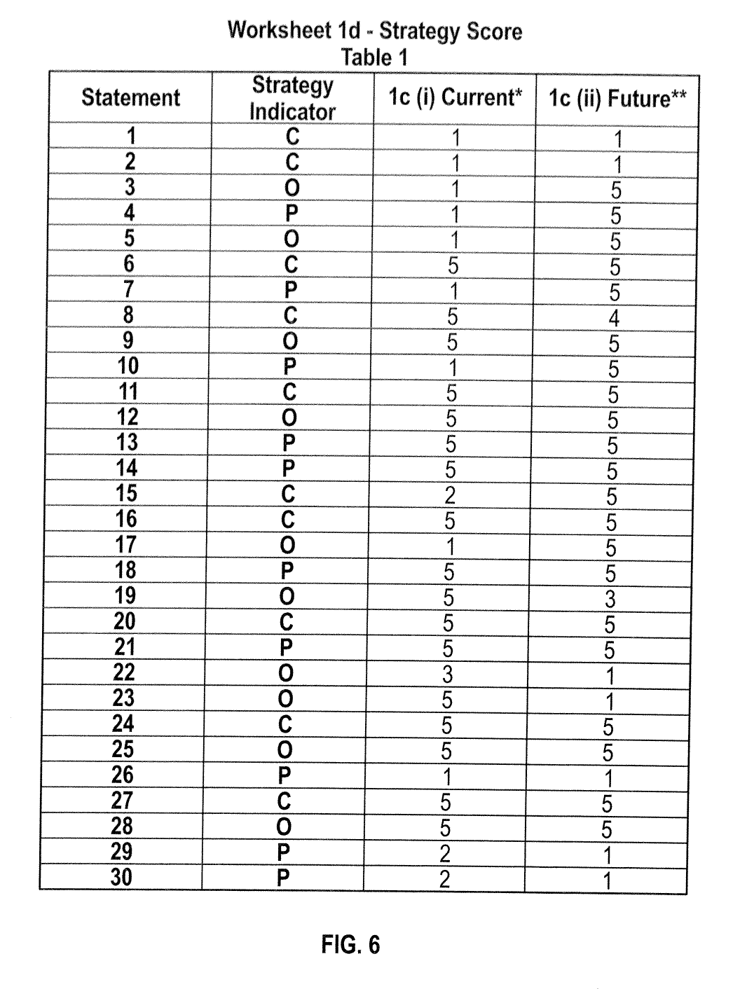

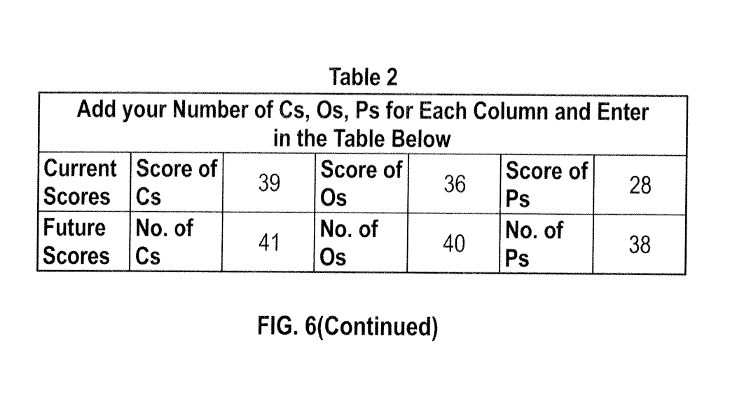

With worksheet 1c(i) completed as shown in FIG. 5, the next step is to transfer the scores to worksheet 1d under heading “1c(i) current” which is shown in FIG. 6.

As explained earlier, the questions are carefully crafted and tailored to reflect the three types of business competitive strategy of a business based on the teachings of Treacy and Wiersema (1995). In other words, each question in FIG. 5 is intended to reflect Company A's competence in each of the three competitive strategies.

FIG. 6 under heading “Strategy Indicator” of Table 1 shows the type of competence to which each question relates to with “C” representing “Customer Intimacy”; “0” representing “Operational Excellence” and “P” representing “Product Leadership”.

The scores of C, O, P reflects the level of competence of Company A in the respective competency areas. A minimal level of competence in all three is required, but to be a market leader requires outperforming the competition in one of the three. Each strategy requires a company to emphasize different process, different management structures, different measures of success, and different cultures:

Customer Intimacy: Companies focus on delivering not what the market wants but what specific customers want. Companies do not pursue one-time transactions; they cultivate relationships. Customer intimacy companies specialize in solution development, advisory and consultancy services, and customer services to satisfy targeted customer needs, which often only they recognize, through a close relationship with and intimate knowledge of the customers. The innovation process would be motivated by the needs of targeted customers, focusing on those new product developments and service enhancements that contribute to better customer solutions. Examples of such companies might be IBM™ and Nordstrom™.

Operational Excellence: Companies are not primarily product or service innovators, nor do they cultivate deep, one-to-one relationships with customers. Instead, operationally excellent companies provide middle-of-the-market products at the best price with the least inconvenience. They emphasize measures of the cost, quality, and cycle time of operating process, excellent supplier relationships, and speed and efficiency of supply and distribution process. The proposition to customers is simple: low price or hassle-free service, or both. Wal-Mart™, Costco™, Federal Express™ and Dell Computer™ might be considered as examples of this kind of company.

Product Leadership: Companies concentrate on offering products that push performance boundaries. The proposition to customers is an offer of the best products. These companies emphasize on new invention, leading-edge innovation process that creates new products with best-in-class functionality and brings them to the market rapidly. Moreover product leaders don't build their positions with just one innovation; they continue to innovate year after year, product cycle after product cycle. Nike™, Sony™, Intel™ are some examples of this group.

With the scores populated in Table 1, the scores of each type of competency (C, O and P) is added and indicated in Table 2 in a row “Current scores”. In this example, Company A scored 39 points for “C”—Customer Intimacy, 36 points for “O”—Operational Excellence and 28 points for “P”—Product Leadership under the assessment of Company A's current competitive strategy.

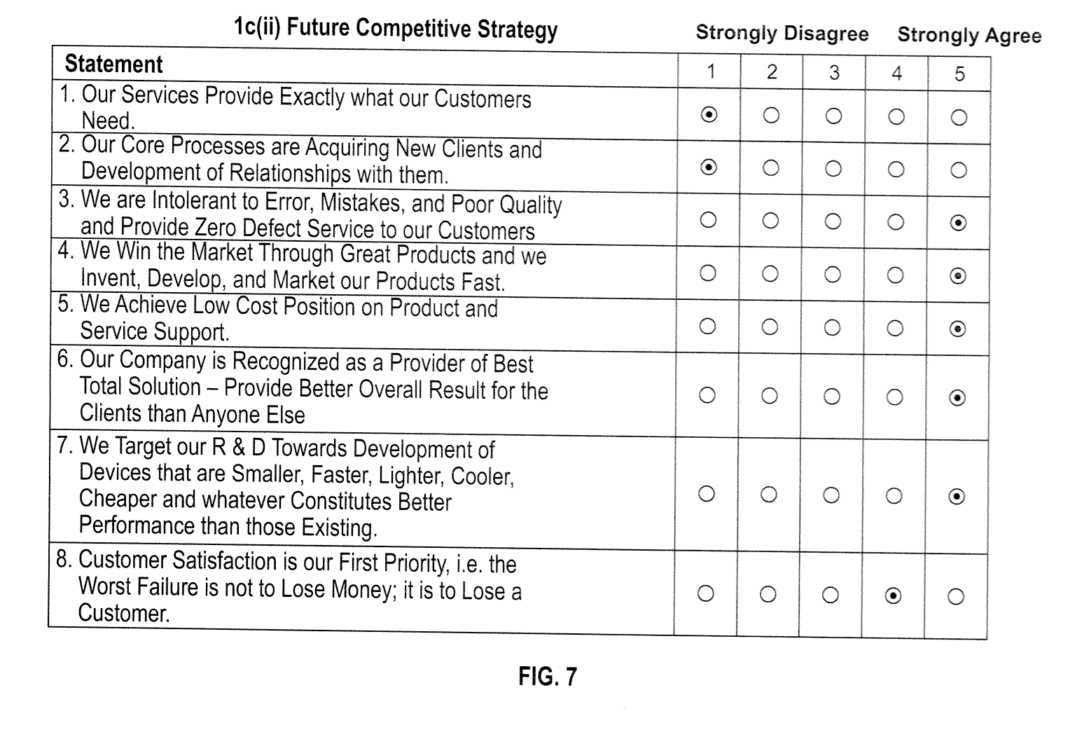

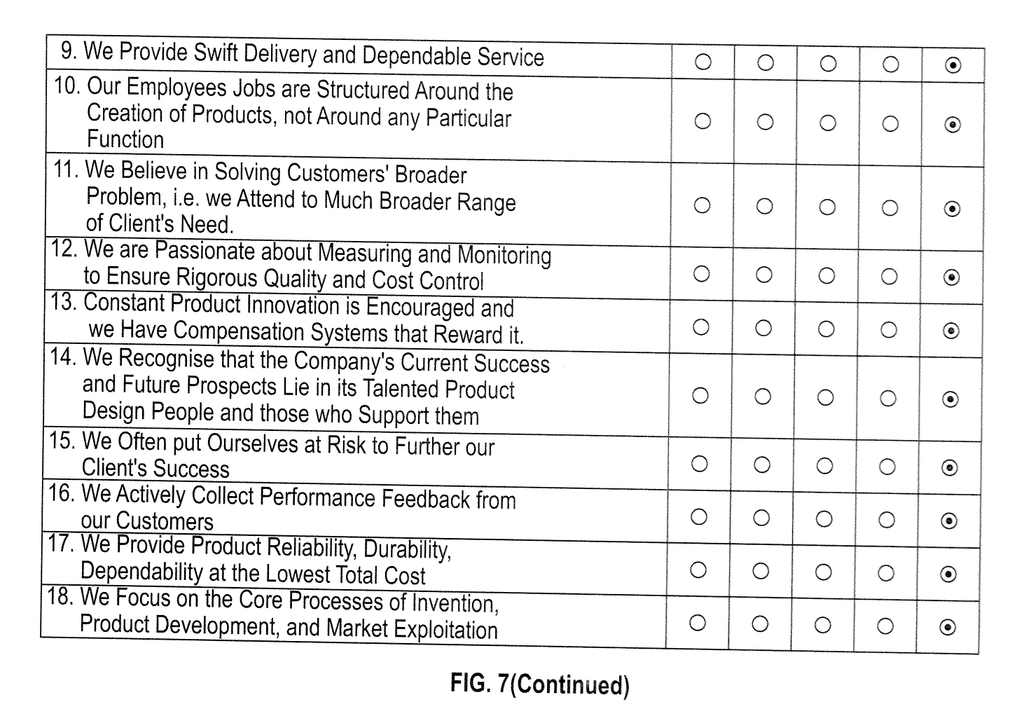

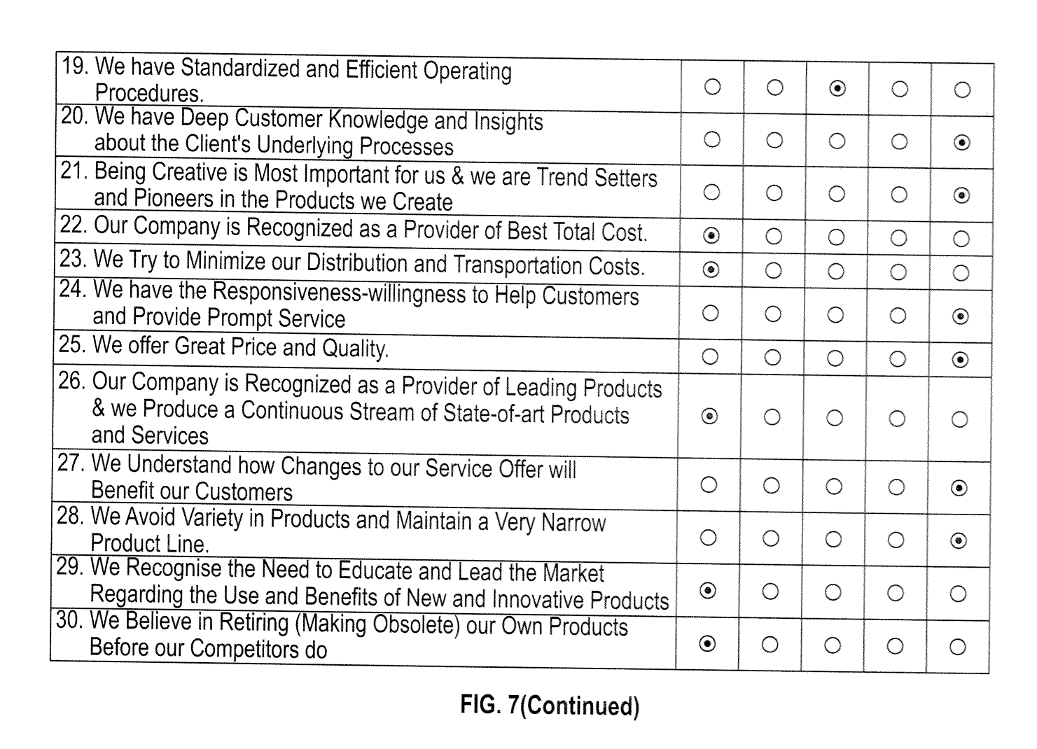

Next, the representatives go back to the same questions as that shown in worksheet 1c(i) of FIG. 5 but this time, the representatives are to answer the questions based on “future competitive strategy” i.e. assess the statements in relation to how the company should be doing business in the future with respect to Company A's main products and customers, taking into account the ideas presented earlier. In this regard, FIG. 7 is worksheet 1c(ii) which shows completed answers by the representatives of Company A and it should be appreciated that the set of questions in worksheet 1c(ii) are the same as those in worksheet 1c(i) of FIG. 5.

It can be appreciated that for question 1 of FIG. 7, as a future competitive strategy, the representatives still maintained that they “strongly disagree” whereas for question 17, they “strong agree” which is a change from the current competitive strategy of FIG. 5.

After completion of the worksheet in FIG. 7, the scores are also populated or mapped to “1c(ii) future” of Table 1 of FIG. 6 and the scores corresponding to each type of competitive strategy (C, O and P) are added and indicated in Table 2 of FIG. 6 in a row corresponding to “Future scores”.

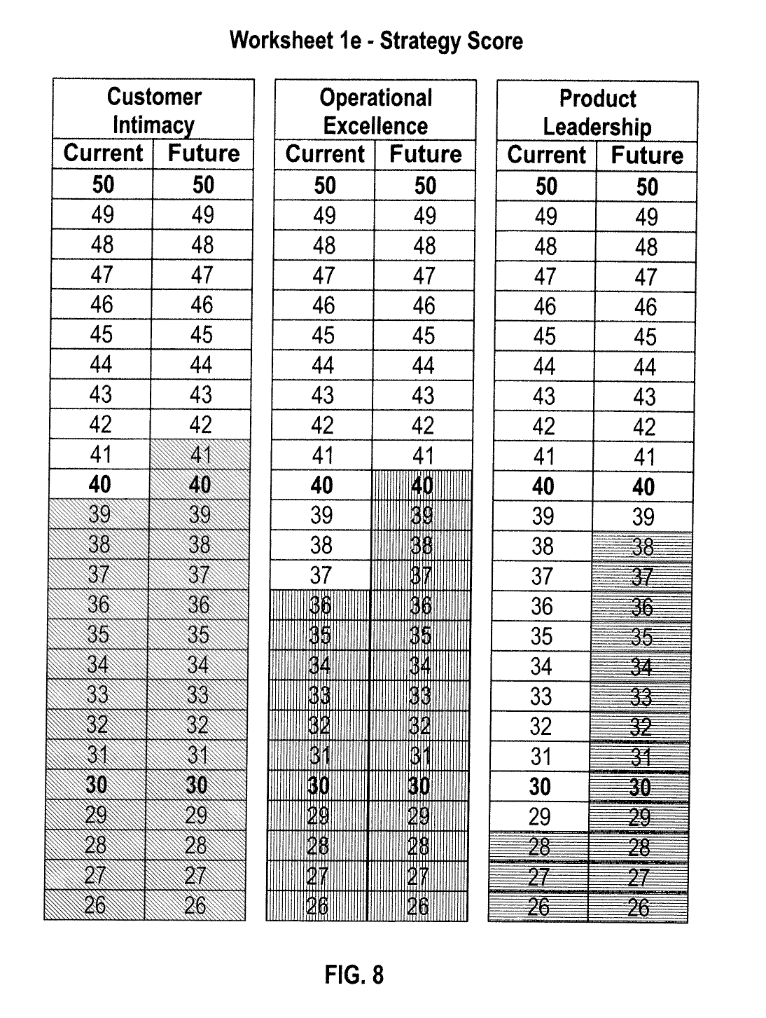

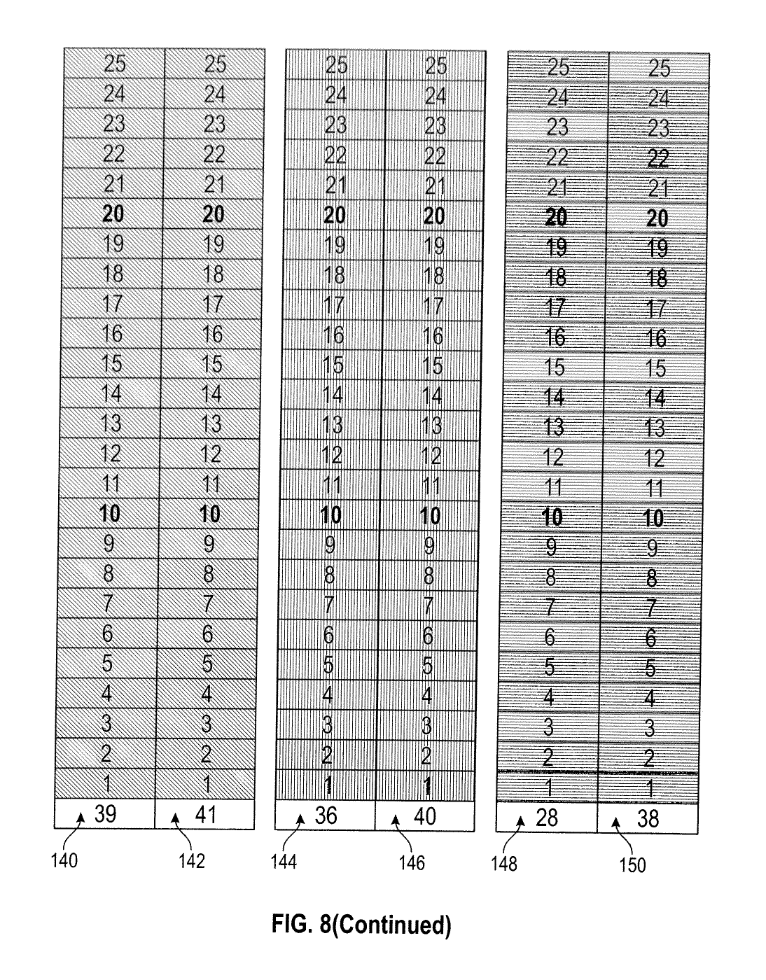

The representatives should discuss the results of the current competitive strategy and the future competitive strategy and the consolidated scores shown in Table 2 of FIG. 6 are then transferred or mapped to worksheet 1e of FIG. 8 as strategy scores 140,142,144,146,148,150 with each one corresponding to current future strategy scores for Customer Intimacy, Operational Excellence and Product Leadership.

To get better results in this section, it is preferred for cross-functional representatives of Company A to complete the current and future competitive strategy in worksheets 1c(i) and 1c(ii) individually and independently. The aggregate scores should then be shown in worksheet 1e of FIG. 8. As a result, the scale of the score in worksheet 1e is flexible to cater to differing views from the representatives.

It should be apparent that the content of the questions in FIGS. 5 and 7 may be changed and the number of questions varied accordingly.

1.3 Analyse Business Competitive Gaps

This section provides an understanding of the business competitive gaps that may exist between what Company A has achieved and what customers want or what competitors do.

Broadly, it is considered that experience and knowledge of Company A's strategy and operations are used as inputs to this section and the outputs are business competitive gaps between the company performance and customer requirements/competitor performance.

To begin, the representatives of Company A review the products offered by Company A and customers being considered and discussed the main customers and competitors. The representatives should already have an idea of Company As customers and competitors from FIG. 4.

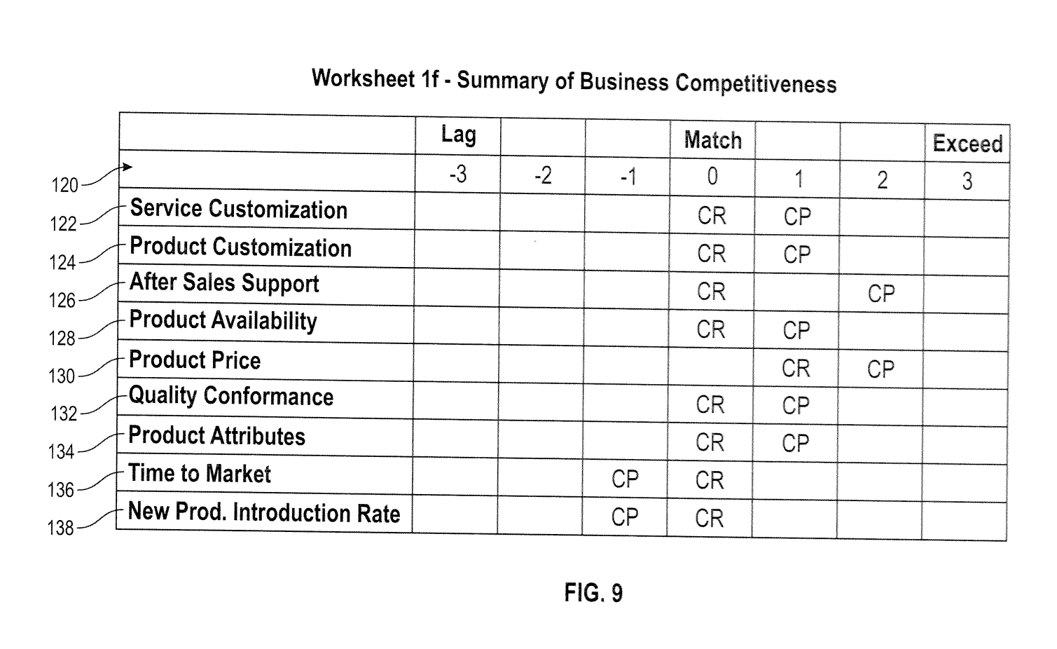

The representatives then reduce their discussion points to a summary of business competitive gaps by completing worksheet 1f of FIG. 9. As shown, worksheet 1f requires the representatives to decide whether each criterion 120 corresponding to Customer Intimacy, Operational Excellence and Product Leadership matches, lags or exceeds customer requirements (CR) or competitor performance (CP). In other words, worksheet if requires the representatives to assess how the current performance of Company A in terms of the criteria 120 compares with the customer requirements (CR). Likewise, worksheet 1g also requires the representatives to assess how the current performance of the company, as measured by the same criteria, compares with the competitor performance (CP).

An explanation of each criterion is provided below:
Customer Intimacy

a) Service customization, 122: Some products sell because the producer is able to offer a tailored service package to customers. The customisation can cover all aspects such as pre-sales activity to understand and meet individual requirements; tailored delivery service such as frequency, volume, and packaging.

b) Product customatization, 124: Some products sell because they suit an individual customer's specification. These include both one-offs, and standard products which have a standard design but which require modification for a particular application. This could also be called design flexibility.

c) After-sales support, 126: This can include technical support, training, repairs, and supply of spares. The range and quality of after-sales services may be critical both in obtaining sales, and in achieving customer loyalty.
Operational Excellence

d) Product availability, 128: This means the supply of a product to a customer on or before the quoted delivery date. In the case where your customer is a consumer, this may mean on-shelf availability. Some companies may call this delivery reliability.

e) Product For some customers, value for money is paramount. In this case, their consideration is of the total cost of purchasing products from you. This total cost will include purchase price as well as other costs of doing business with you, such as time and convenience.

f) Quality conformance, 132: This means both conformance to specification (the product performs as specified) and reliability in use (the product continues to perform for an extended period). Product reliability may be more important to a customer than other attributes such as technological or aesthetic considerations.
Product Leadership

g) Product attributes, 134: A product may sell because it has some feature that is not available from competitors (latest or unique technology perhaps), or because its performance in a particular feature is superior to its competitors. In some cases, market position is affected by the product variety on offer.

h) Time to market, 136: This is concerned with how effective you are at converting ideas into products. In some markets, the firm that gets the orders is the one that gets its products and services on to the market first. This measure will be affected by your ability to manage the development or design of the process required to get your new products from concept stage to market place.

i) New product introduction rate, 138: This is about the amount of innovation taking place within the company. It can be measured by counting the number of new or enhanced products or services introduced each year.

As it can be seen from FIG. 9, the representatives of Company A thinks that in terms of Service customization 122 and Product customization 124, they meet the customers requirements (CR in the column corresponding to “0” which means it “Match” the customer requirements) whereas for these two areas or criteria, they just about exceed the competitors' performance (as represented by “CP” in the column under “1”). It -should be apparent from FIG. 9 the representatives' views on the other criteria.

For better results, it is preferred for the representatives of Company A to obtain actual views from their customers in order to complete the worksheet of FIG. 9. This might be by way of speaking to their customers to get feedback, carrying out customer surveys and getting customers involved in order to obtain their customers' opinions and requirements.

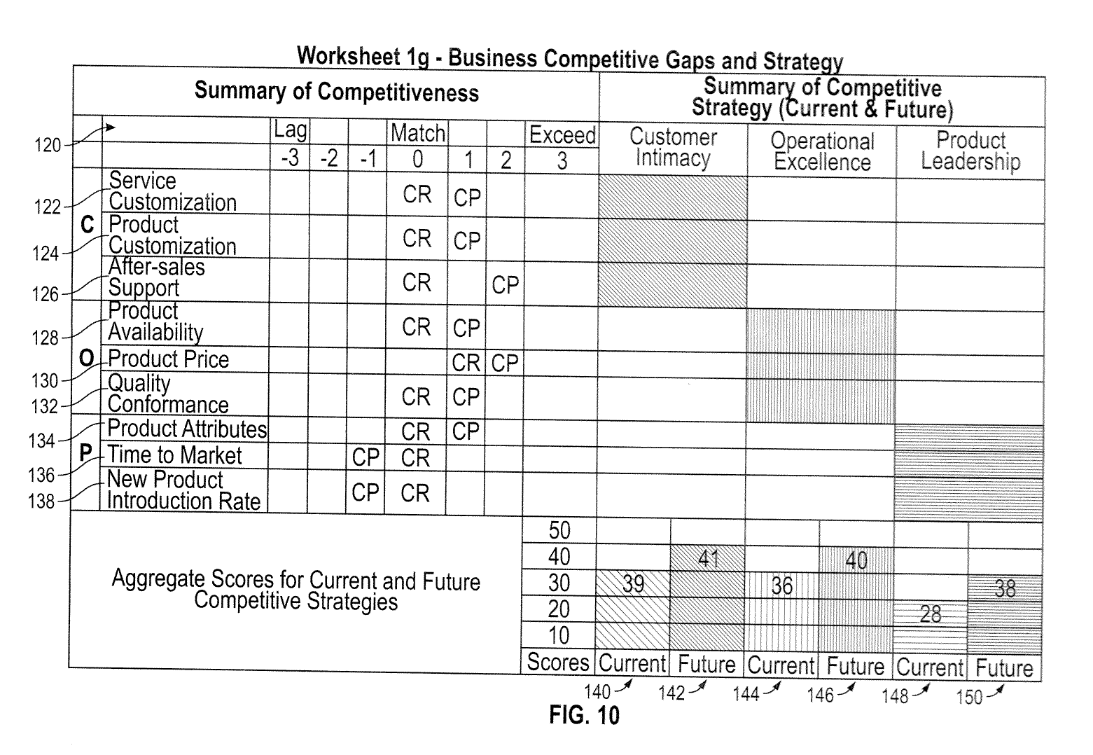

After completing FIG. 9, the representatives next use the information in FIG. 9 to complete worksheet 1g of FIG. 10 which is a summary of business competitive gaps (of FIG. 9) and strategy (of FIG. 8 or Table 2 of FIG. 6). The business competitive gaps 120 are represented in rows in worksheet 1g of FIG. 10 and the business strategy scores 140.142,144,146,148,150 are represented in columns in the right hand side of FIG. 10. In this way, the representatives are able to correlate the competitive gaps with the strategy scores which they derived at earlier and use this as basis to discuss Company A's current competitive gaps against the current and future competitive strategy.

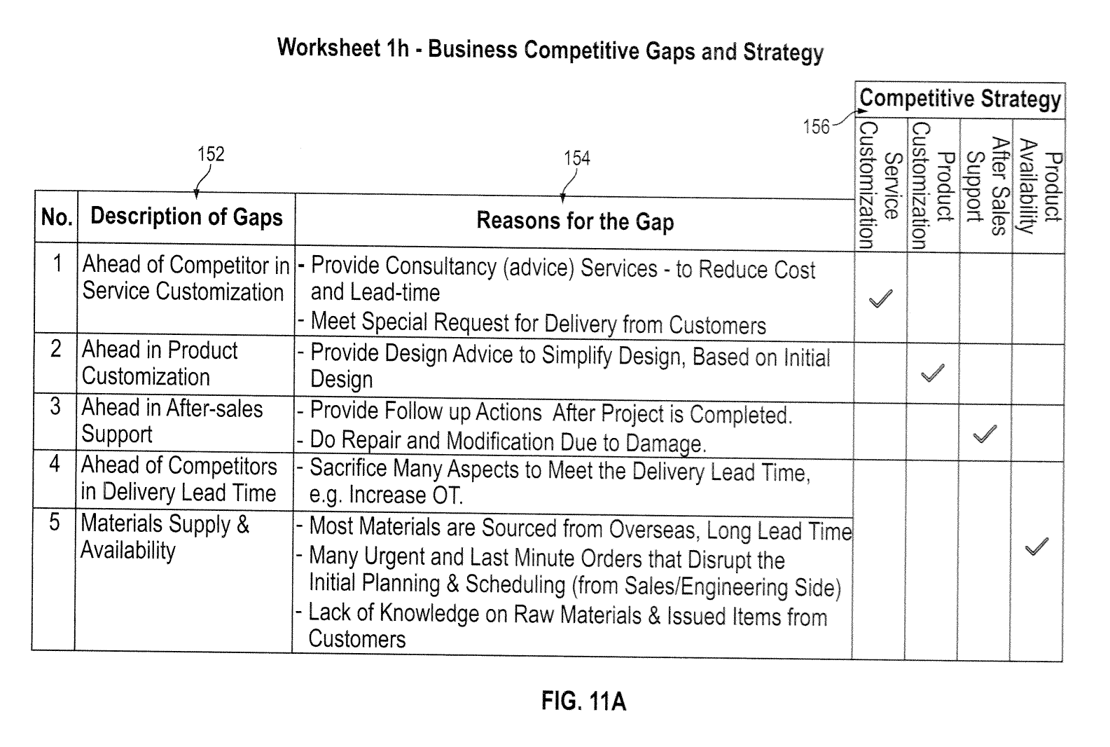

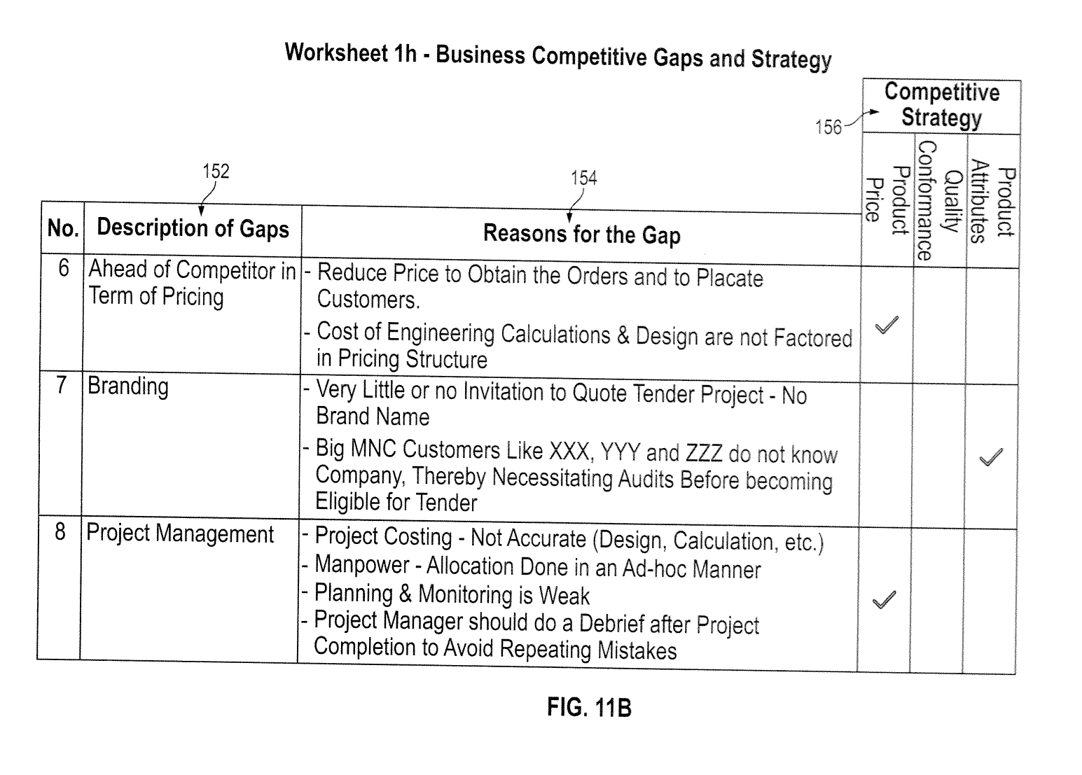

From the discussion, the representatives describes the competitive gaps in more detail and records this in worksheet 1h of FIGS. 11a and 11b as “Description of gaps” 152, provide “Reasons for the gap” 154 and align the gaps 152 to a respective competitive strategy 156. In this example, the representatives of Company A notes that they are “ahead of competitor in service customization” and the reasons provided by them is that they “provide consultancy (advice) services to reduce cost and lead-time”, and also “meet special request for delivery from customers”, this being aligned to “service customization” criterion.

In terms of “Branding” in FIG. 11b, the representatives believe that they get very little or no invitation to quote for projects and Company A has no brand name.

With the worksheets in FIGS. 11a and 11b completed, the method 1000 moves on to the next section.

1.4 Determine Business Objectives

It should be apparent that the previous sections provide the representations of Company A an understanding of the company performance and future competitive strategy, and business competitive gaps that exist between the company and customer requirements/competitor performance.

This section provides structured analysis and identification of business objectives to address or narrow the competitive gaps and align to the competitive strategy.

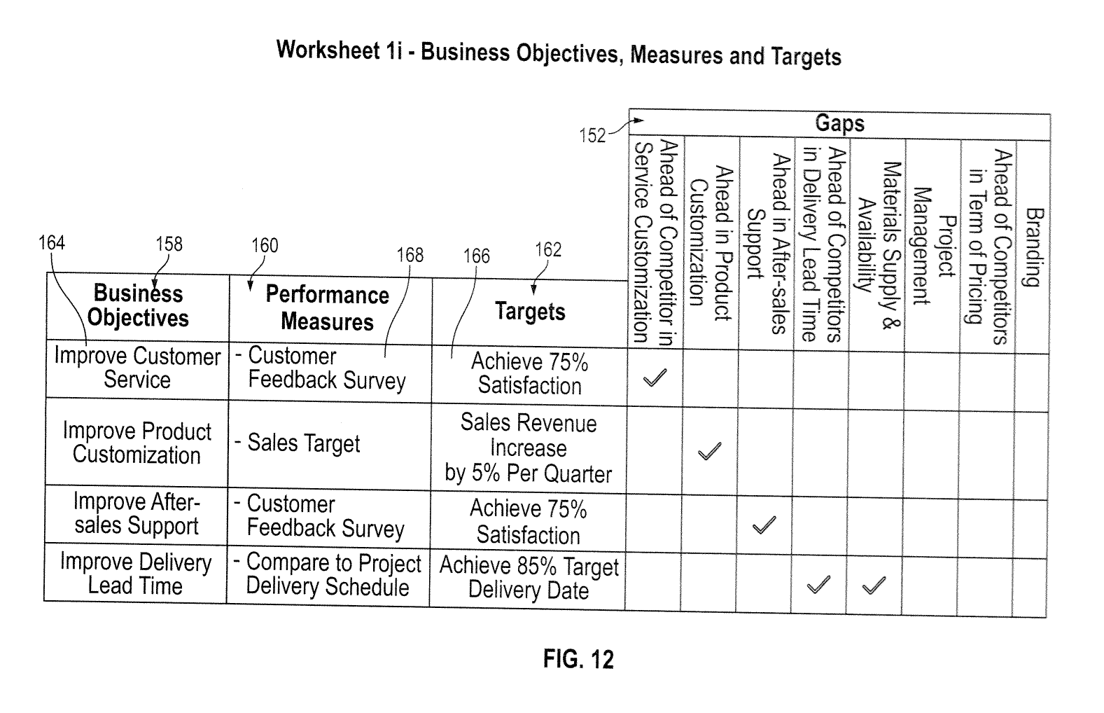

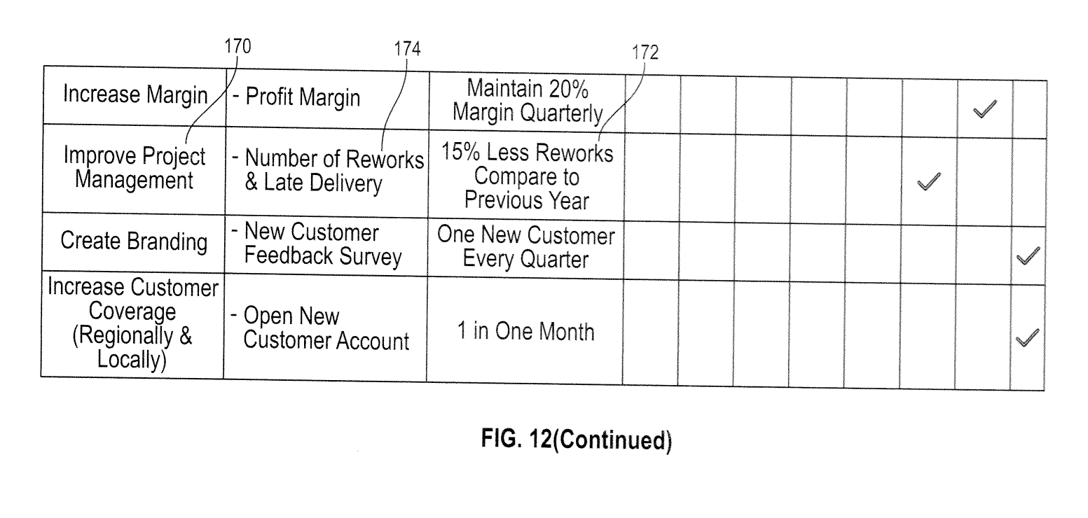

A first step is to arrange the description of gaps as headings in columns of worksheet 1i of FIG. 12 and thereafter, fill in details for headings “Business Objectives” 158 and also complete the headings “Performance Measures” 160 and “Targets” 162 associated with each business objective.

To do this, the representatives review worksheet 1g of FIG. 10 and worksheet 1h of FIGS. 11a and 11b to analyse the current and future competitive strategy and the competitive gaps and identify the business objectives 158 which address or narrow the competitive gaps of the company and which are aligned to the competitive strategy. The business objective is then recorded in worksheet 1i. For example, to address the competitive gap of “ahead of competitor in service customization”, the business objectives identified is “Improve customer service” 164.

The representatives also have to decide a target under “Targets” 162 for improving the customer service 164 and the target should be a quantifiable target so that there is a way of measuring using “Performance measures” 162 whether the target is achieved or not. In this example, the representatives decides that they wish to achieve 75% customer satisfaction 166 and this would be measured by using “Customer feedback survey” 168 as the “Performance measures” 160.

Taking another example in FIG. 12, to address the gap “Project management”, the business objective 158 is to “Improve Project Management” 170 and the associated quantifiable target is identified as to achieve “15% less rework compared to previous year” 172. This target 172 is measured by “The number of reworks and late delivery” 174.

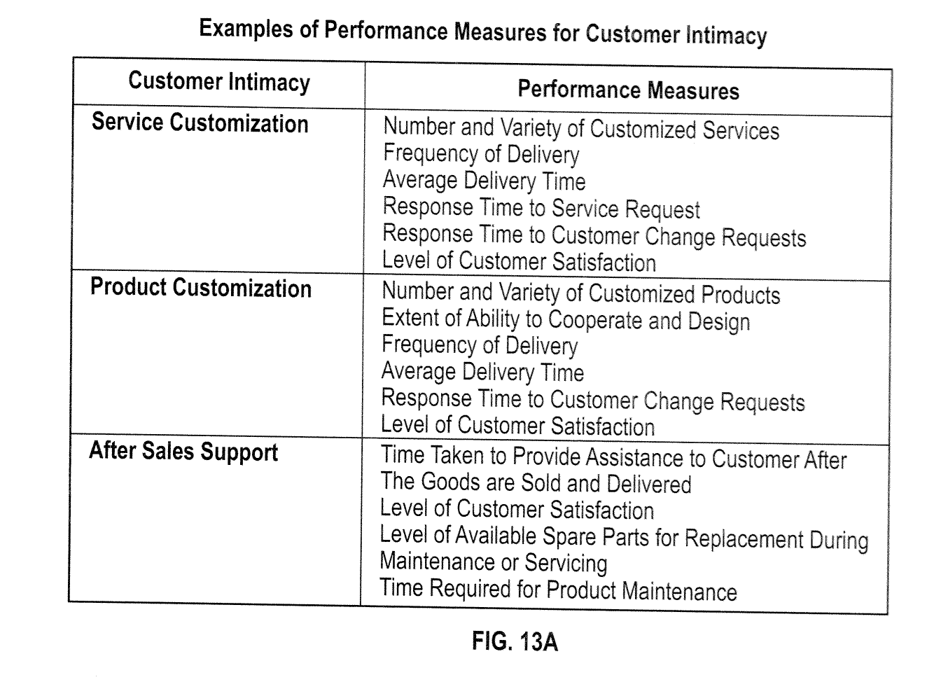

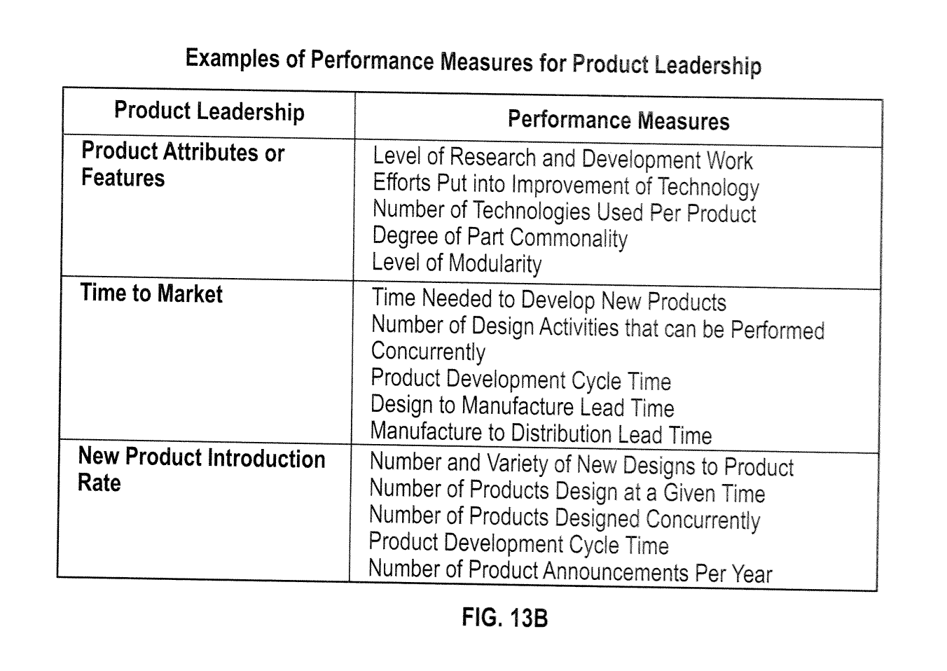

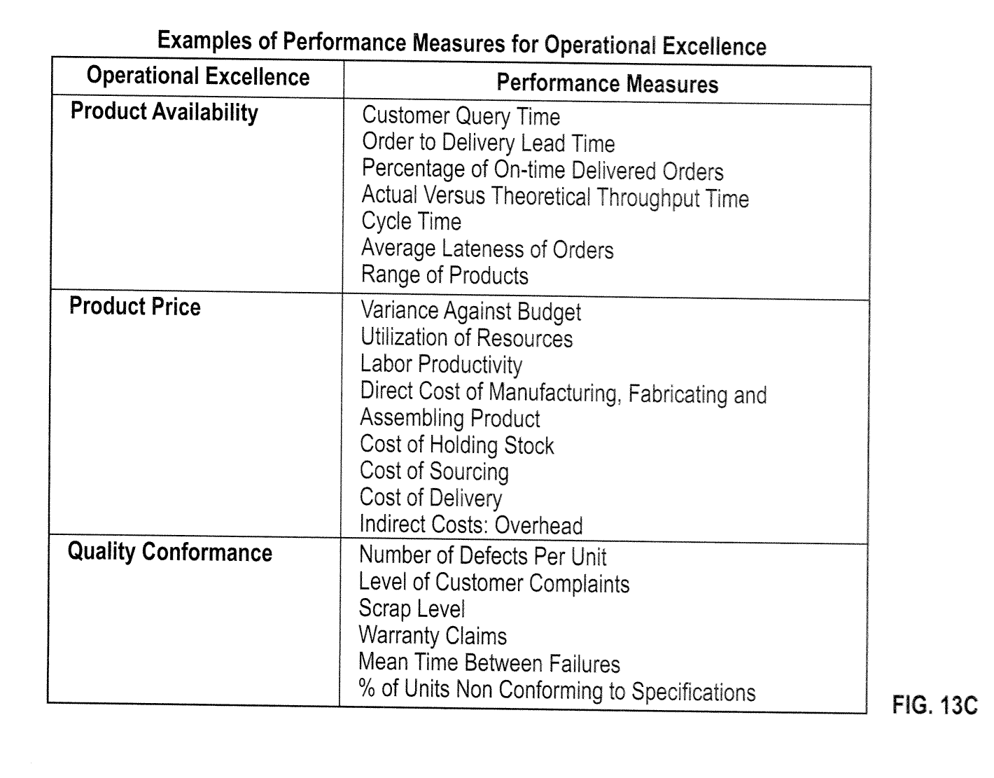

FIGS. 13a, 13b and 13c are examples of performance measures for the respective competency areas of Computer intimacy, Product leadership and Operational Excellence which may be considered by the representatives when completing worksheet 1i of FIG. 12.

With the output of FIG. 12 in particular the definition of the business objectives 158, this ends Stage 1 of the method 1000 and the method proceeds to Stage 2.

Stage 2 (200): Identify Activity Landscape

An objective of Stage 2 is to produce an unfiltered landscape of activities for Company A that is involved in delivering the products (or services) identified at Stage 1. The landscape of activities or activity landscape broadly comprises process for both material and information flow of Company A and are mapped to an organization structure and process of Company A.

2.1 Understand Organization Structure of Company A

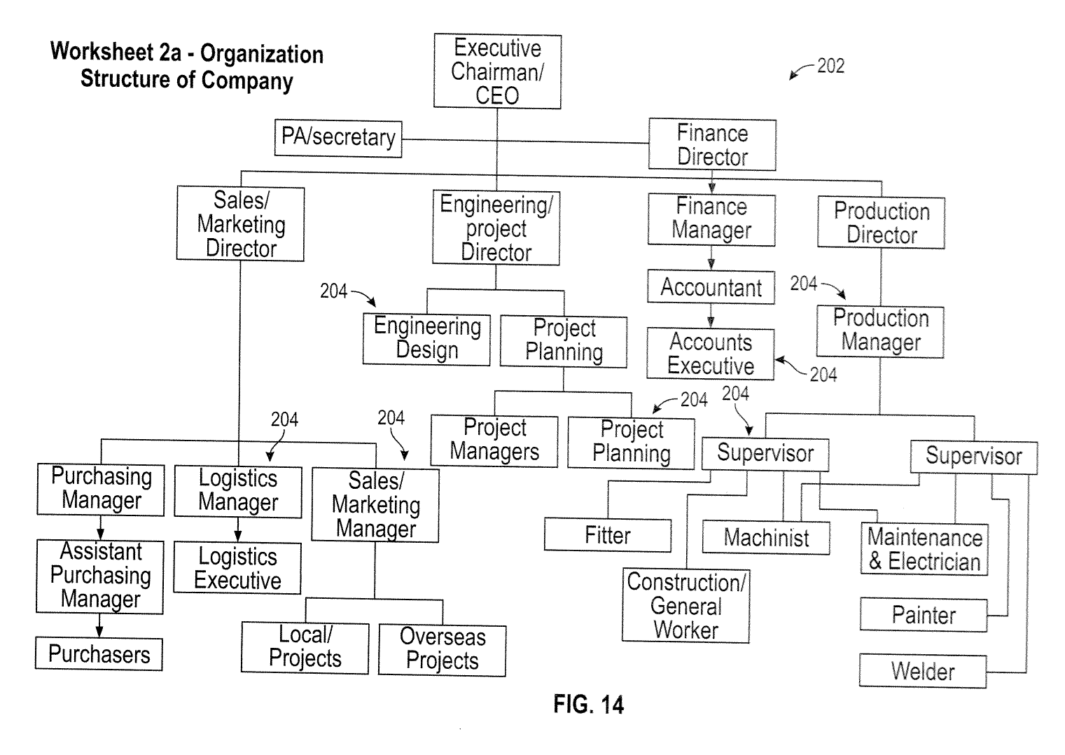

At this section, the organization structure 202 of Company A is reviewed so that there is an understanding of the different functional groups 204 for Company A. Specifically, the functional groups 204 are those involved or responsible for delivering the products (or services) identified in Stage 1. The organization structure 202 is then recorded on worksheet 2a of FIG. 14 which should also be used as the basis for discussion.

In this way, it forces the representatives of Company A to put down in writing the organization structure and if Company A did not have such the organization structure 202 recorded, having this section ensures that they do so, so that the representatives would have a good understanding of the various functional groups 204 which made up Company A.

2.2 Check Alignment Between Business Objectives and Various Functional Groups

At this section, it should be appreciated that the representatives have the business objectives already defined in worksheet 1i of FIG. 12 and the various functional groups 204 of the business also defined in the organizational structure 202 in worksheet 2a of FIG. 14. An aim of this section is to align or map each business objectives 158 to one or more functional groups of the organizational structure 202 that may contribute to achieve the defined business objectives 158.

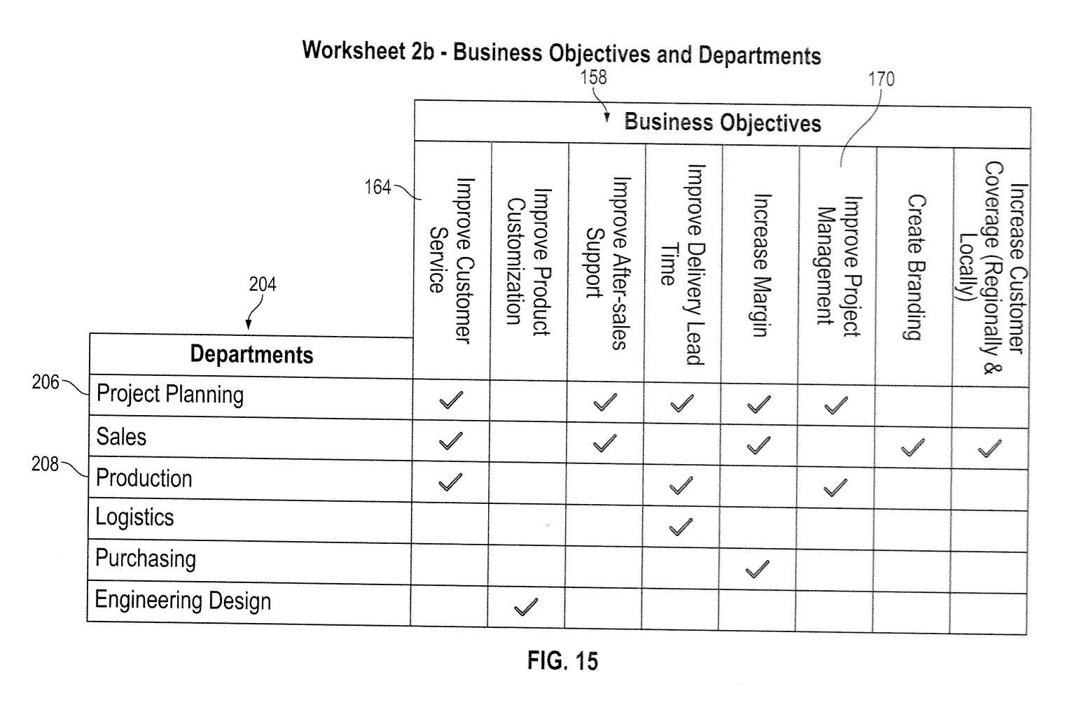

As a result, it would be appropriate to review and analyse worksheet 1i of FIG. 12 on the business objectives 158 defined earlier and worksheet 2a of FIG. 14 on the organization structure of Company A. From the analysis, the representatives identify and select the related functional groups (or sections/departments/agencies etc) that can contribute to achieving the defined business objectives 158 and these are recorded in worksheet 2b of FIG. 15.

As it can be appreciated, the business objectives 158 defined in worksheet 1i of FIG. 12 are presented as column headings with the identified functional groups 204 represented as row headings to form a table. For example, for the business objectives “Improve customer service” 164 and “Improve project management” 170, functional groups “Project Planning” 206 and “Production” 208 are both identified as being able to contribute to achieving these business objections 164. 170. Thus, the corresponding boxes are checked.

2.3 Identify Current Activity Map

With the relationships between the business objectives and the functional groups of the business defined in worksheet 2b of FIG. 15, these are used as inputs in this section in order to identify the current activity map. In other words, this section proceeds from the organization level identified in the previous section to the activity level within the identified related departments or functional groups. This section concerns the identification of the activity maps in company A. The activity maps reveal the work process for both the material and information flows in company A.

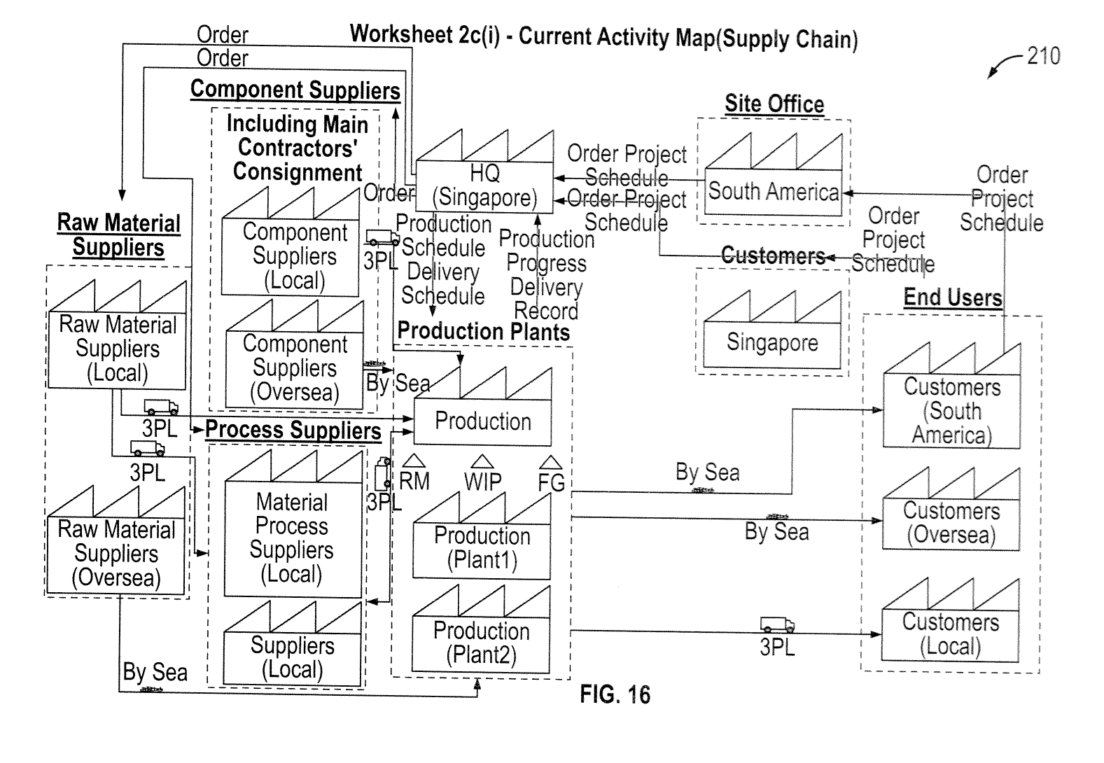

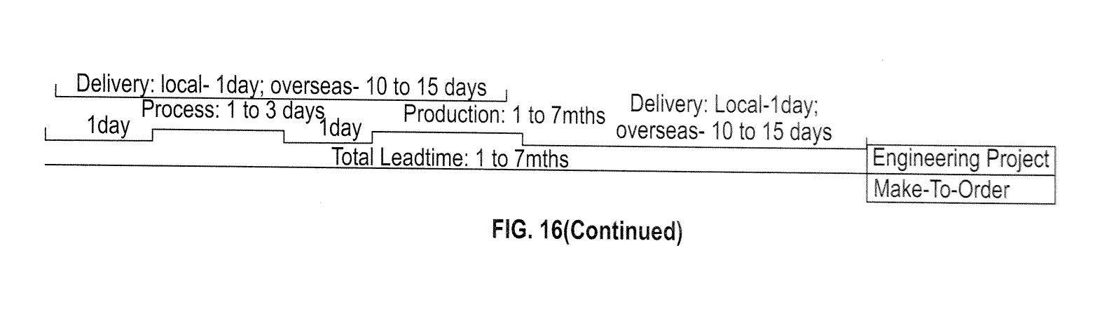

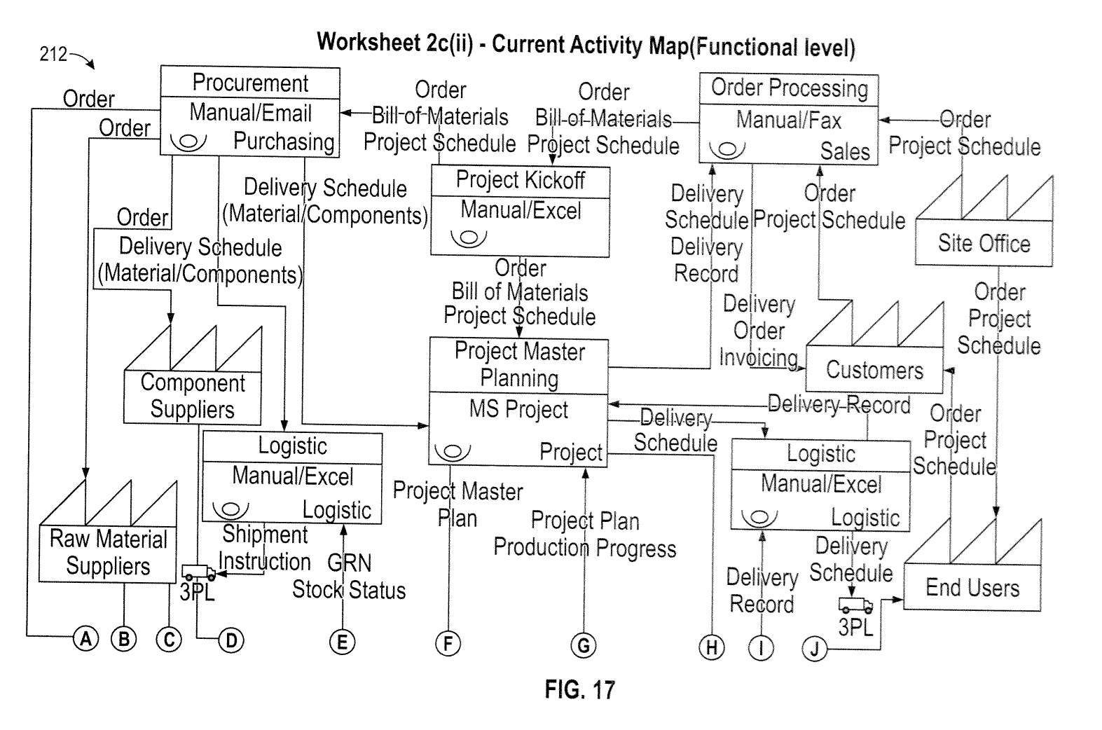

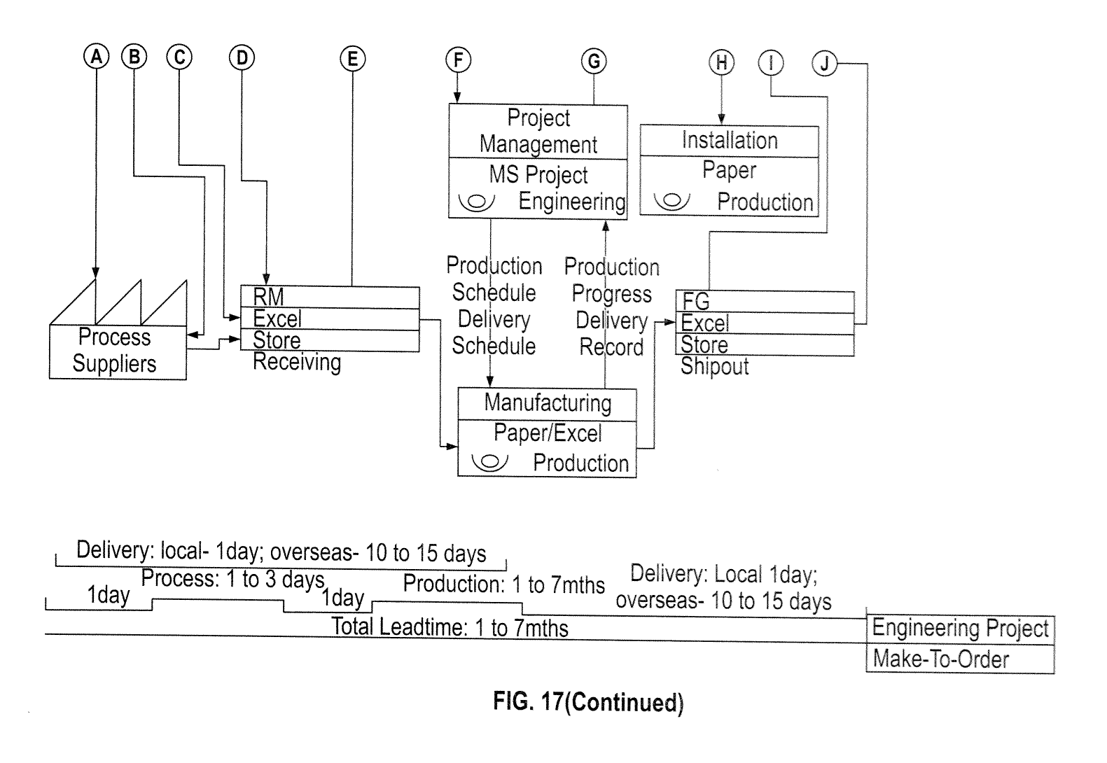

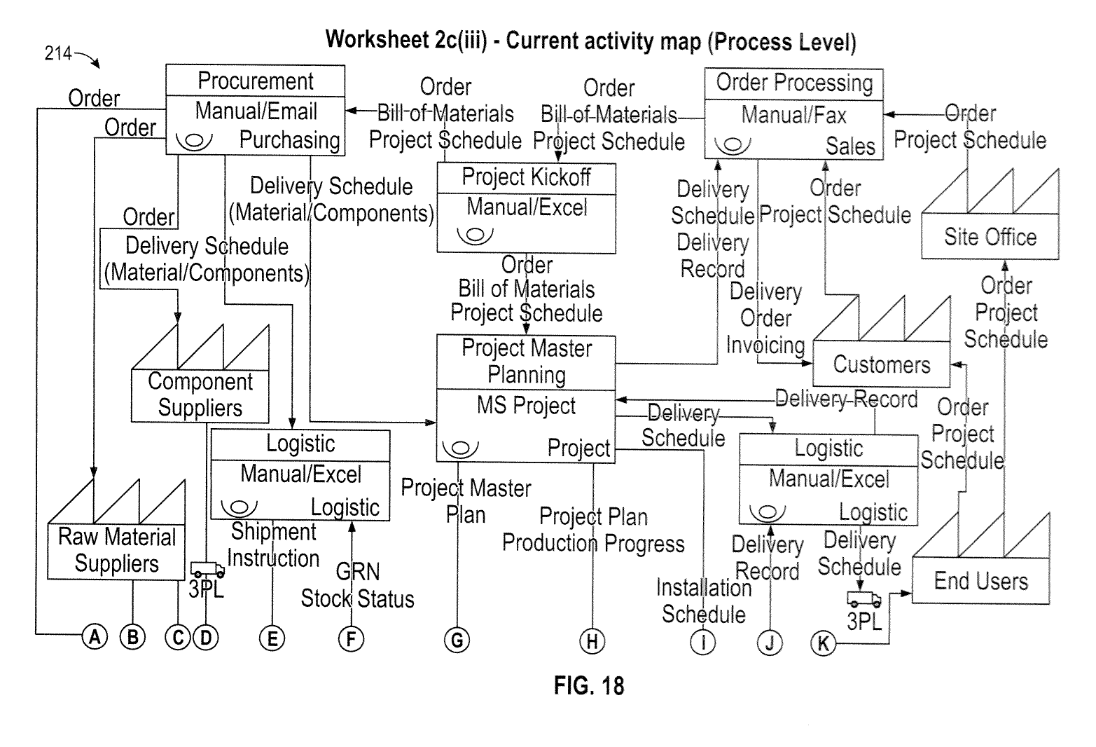

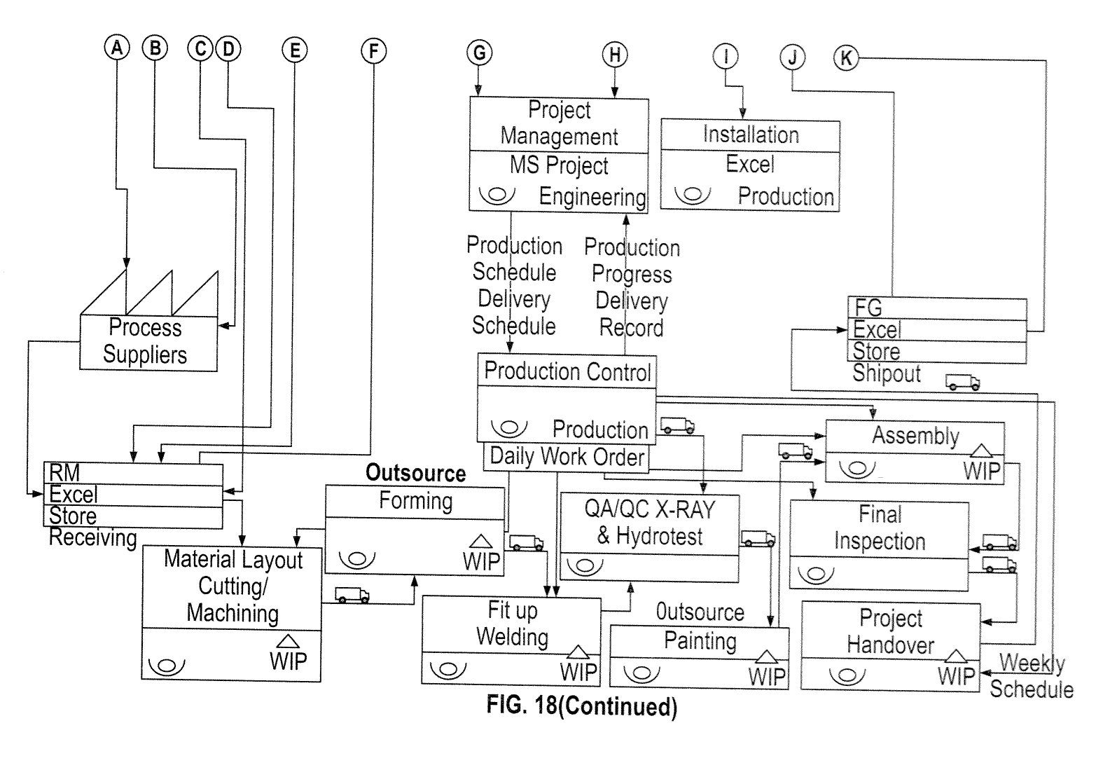

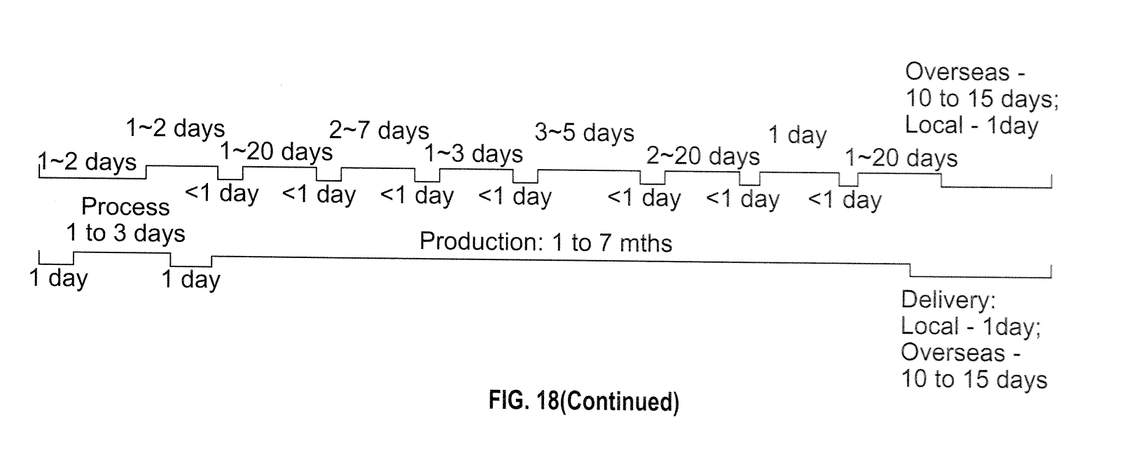

From Worksheet 2b on the related departments, sketch current activity maps of Company A which comprise current sequences of work process for both the material and information flow. FIG. 16 is worksheet 2c(i) which illustrates a current activity map of a supply chain 210 for Company A. FIG. 17 is worksheet 2c(ii) which illustrates the current activity map 210 of FIG. 16 at a functional level 212. The representatives of Company A also sketched the current activity map 210 at a process level 214 and this is illustrated in worksheet 2v(iii) of FIG. 18. In this way, different granularity levels of the work process of Company A are depicted and illustrated.

There are no strict rules on which method to use to map all the activities of Company A at this section as long as all activities are mapped and there is no filtering. Specifically, the activity map should capture i) information flow, ii) physical product flow, which includes raw material, finished goods, work-in-progress etc, iii) process parameters, iv) transportation models, and v) lead time etc.

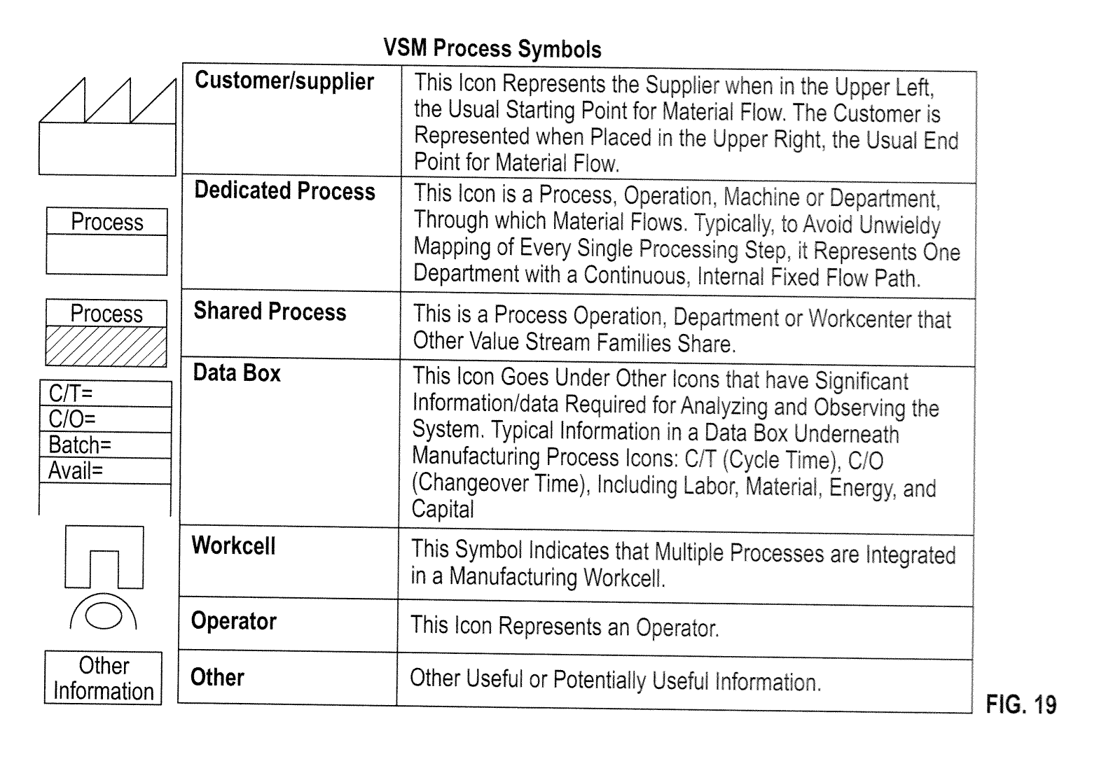

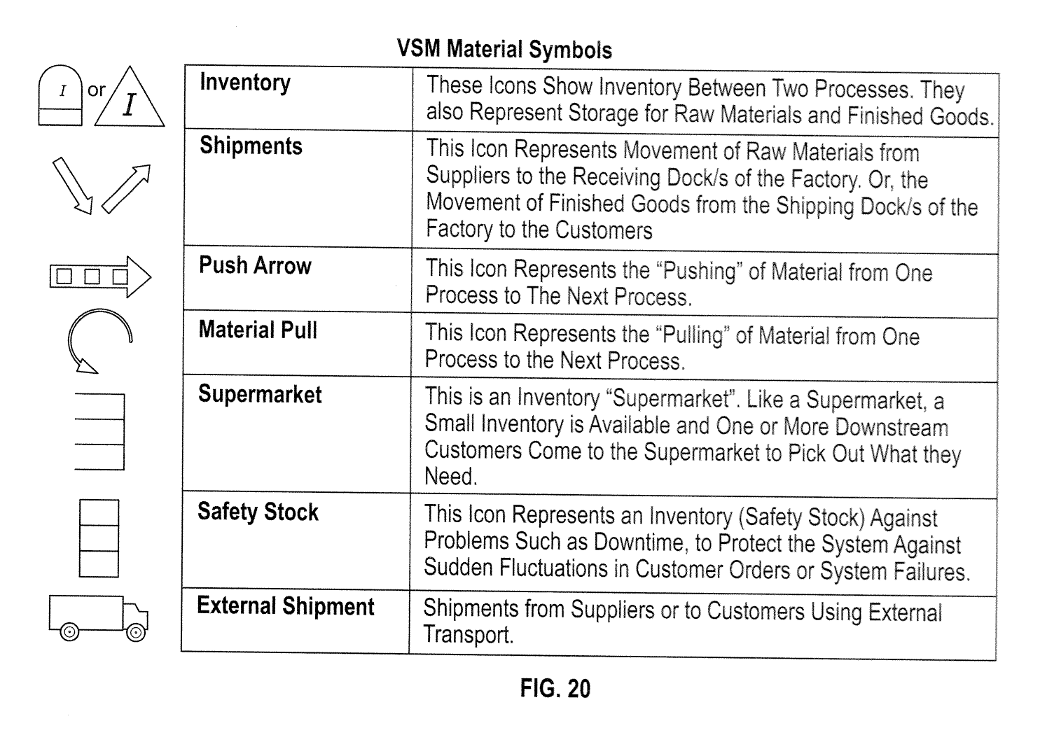

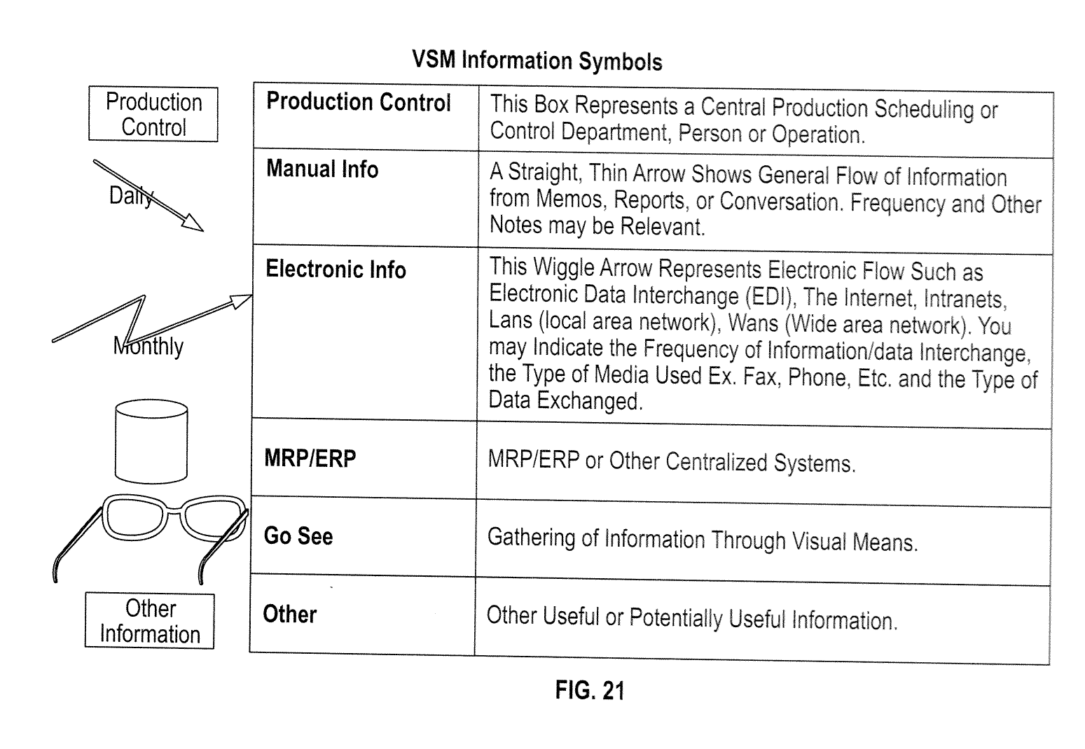

It is suggested to use Value Stream Mapping (VSM) method and examples of VSM symbols are provided in FIGS. 19, 20 and 21 which provide examples of VSM process symbols, materials symbols and information symbols respectively, which may be used for the activity mapping exercise. VSM is a good method to document the material and information flows represented by different symbols on the map. It serves as a good communication tool to provide a comprehensive picture of the current system.

When considering or identifying activities, it is important that they are considered and identified at the appropriate level.

It should be appreciated that the analysis and review of Company A's organizational structure may be conducted at other stages of the method 1000, and not at Stage 2. For example, some may find it beneficial to review the organizational structure from the onset i.e. at Stage 1.

With the activity maps of Company A defined, the method 1000 is ready to proceed to Stage 3.

Stage 3 (300): Identify Improvement Areas and Assess Productivity

An aim of Stage 3 is to identify at least one improvement area and to assess current productivity of the at least one improvement area. The improvement area comprises an activity or a group of activities identified in the current activity maps of Stage 2 which have significant contribution to the business objectives 158 or strategies. The improvement area provides a link to the activities of Company A.

3.1 Identify Improvement Area(s)

It is important that the improvement area is aligned to the business objectives 158 defined earlier at Stage 1 and thus, the business objectives 158 of Stage 1 and the activity maps 210,212, 214 of Stage 2 are used as “inputs” to this section with the output form this section being one or more improvement areas.

To begin, the representatives review the business objectives 158 in worksheet 1i of FIG. 12 and the activity maps 210,212,214 in worksheets 2c(i), 2c(ii) and 2c(iii) to analyze which activities have potential to contribute significantly to the business objectives.

The analysis is made much simpler with the activity maps 210,212,214 since the representatives are able to appreciate visually the work process of the company for example, information flow, material flow, timings of each activity, where stocks are held etc. It makes it easier for the representatives to identify the improvement areas such as missing information linkages, too much stock, cycle-time or lead-time to arrive at the areas for improvement.

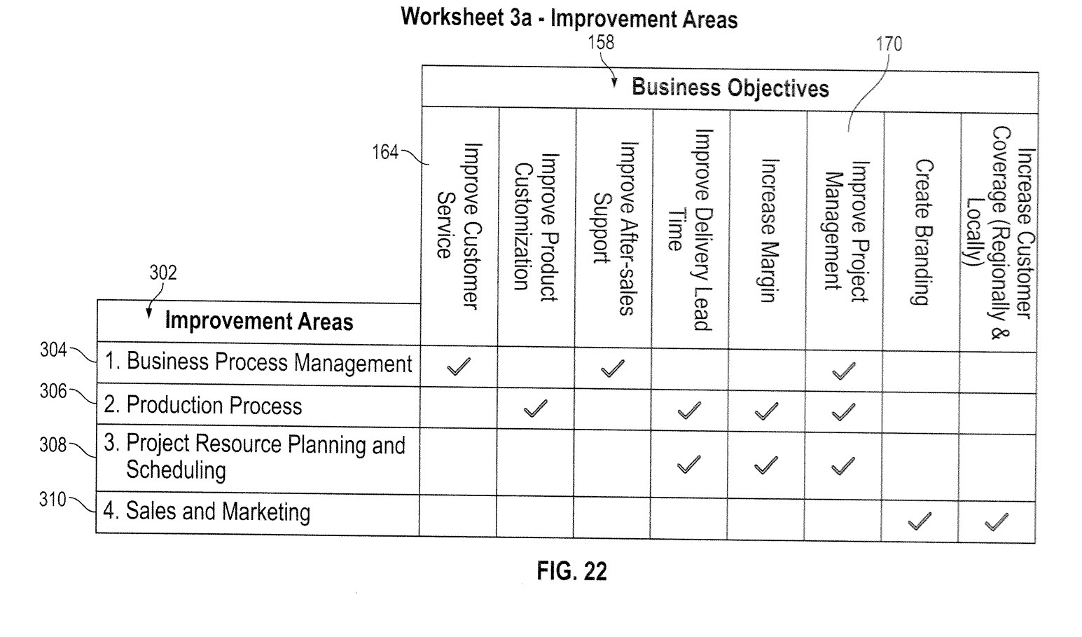

The improvement areas are then recorded in worksheet 3a of FIG. 22 and aligned to the respective business objectives 158 and in this embodiment, the representatives have identified four improvement areas 302 in the current activity map 210 of FIG. 16 and these are:
A. Business process management 304;
B. Production process 306;
C. Project resource planning and scheduling 308;
D. Sales and marketing 310.

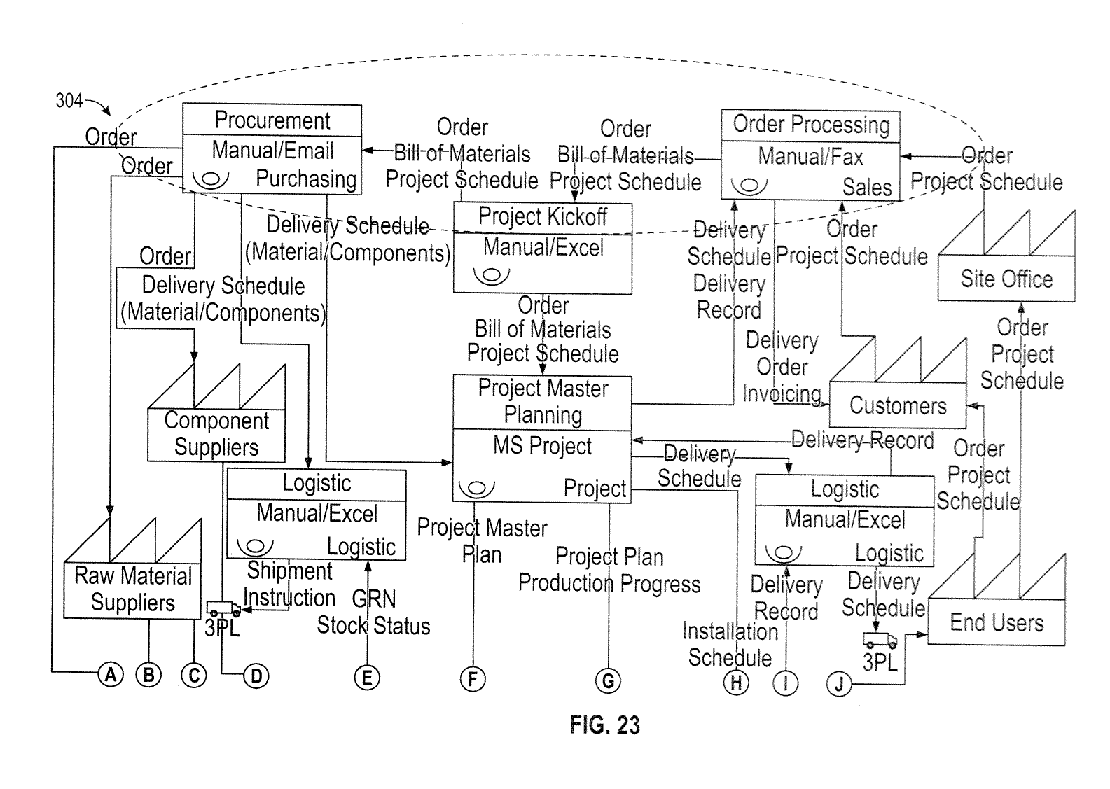

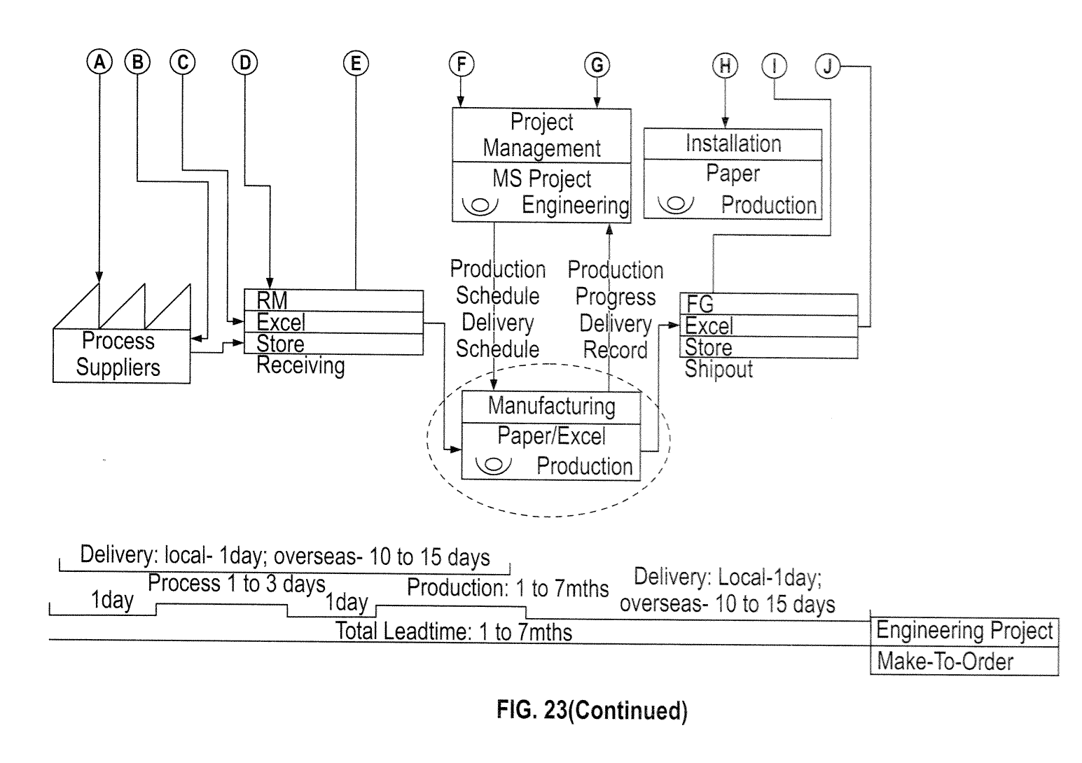

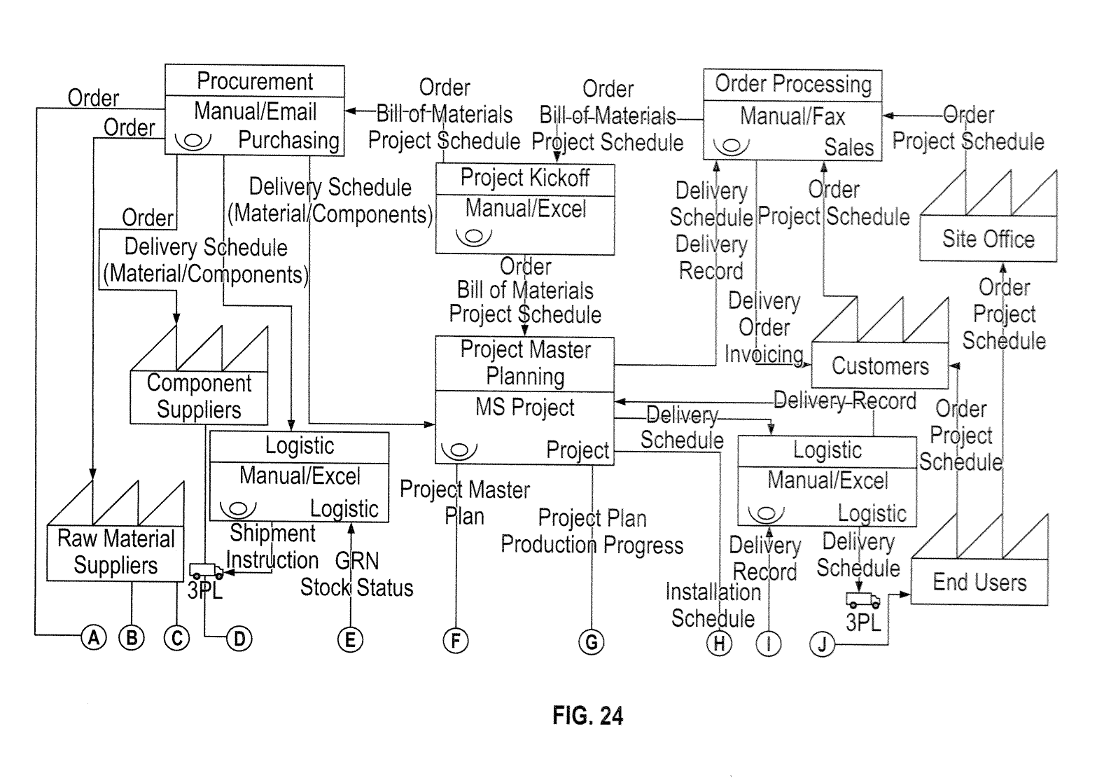

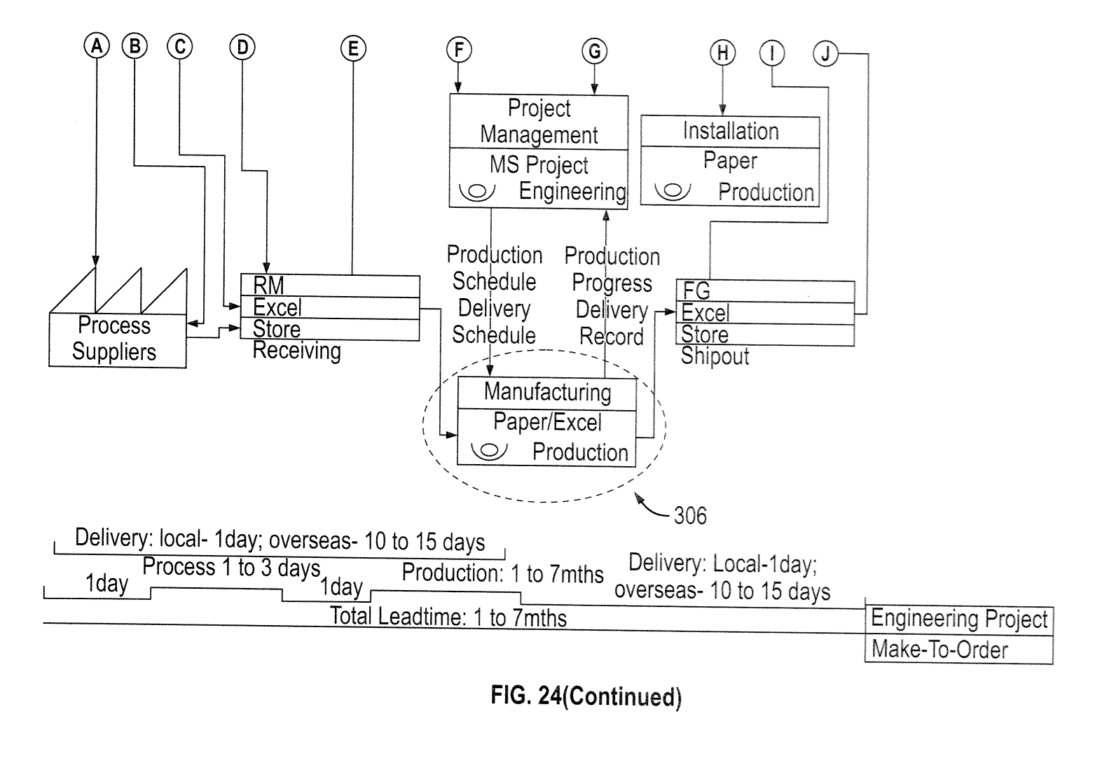

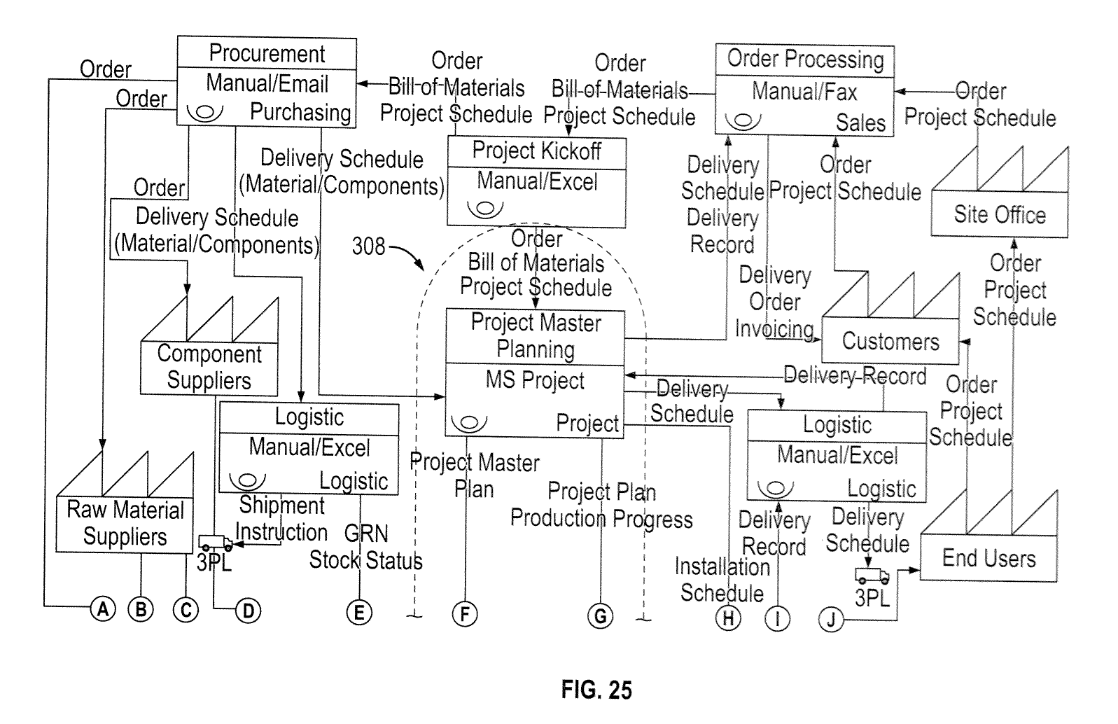

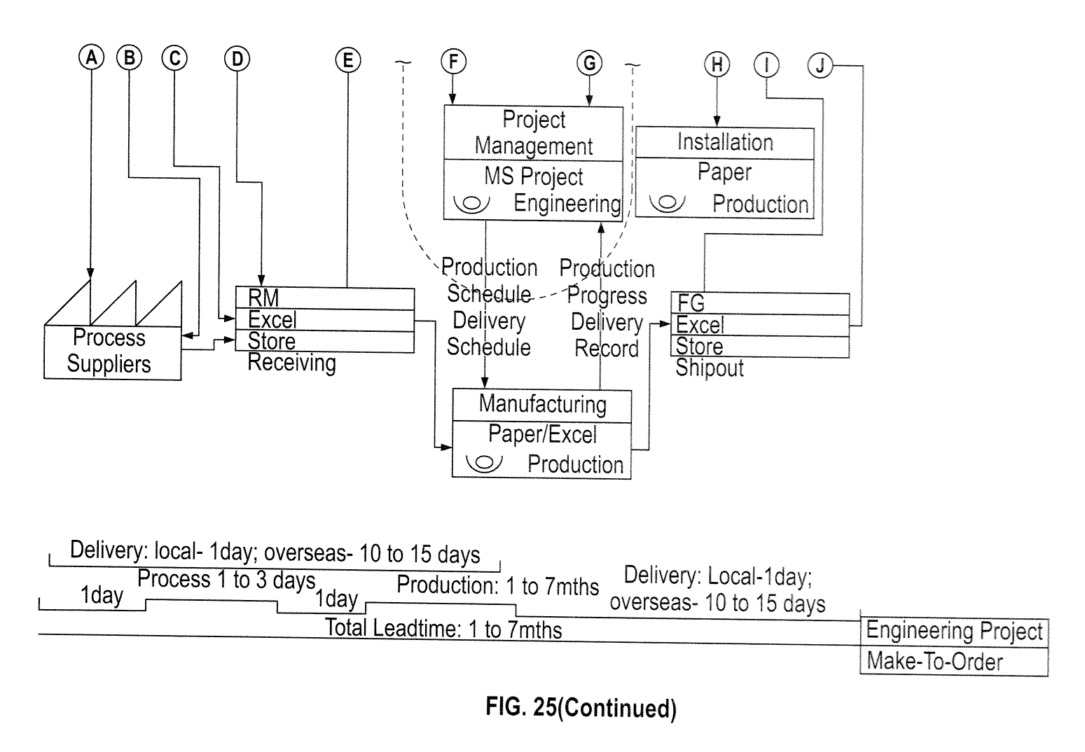

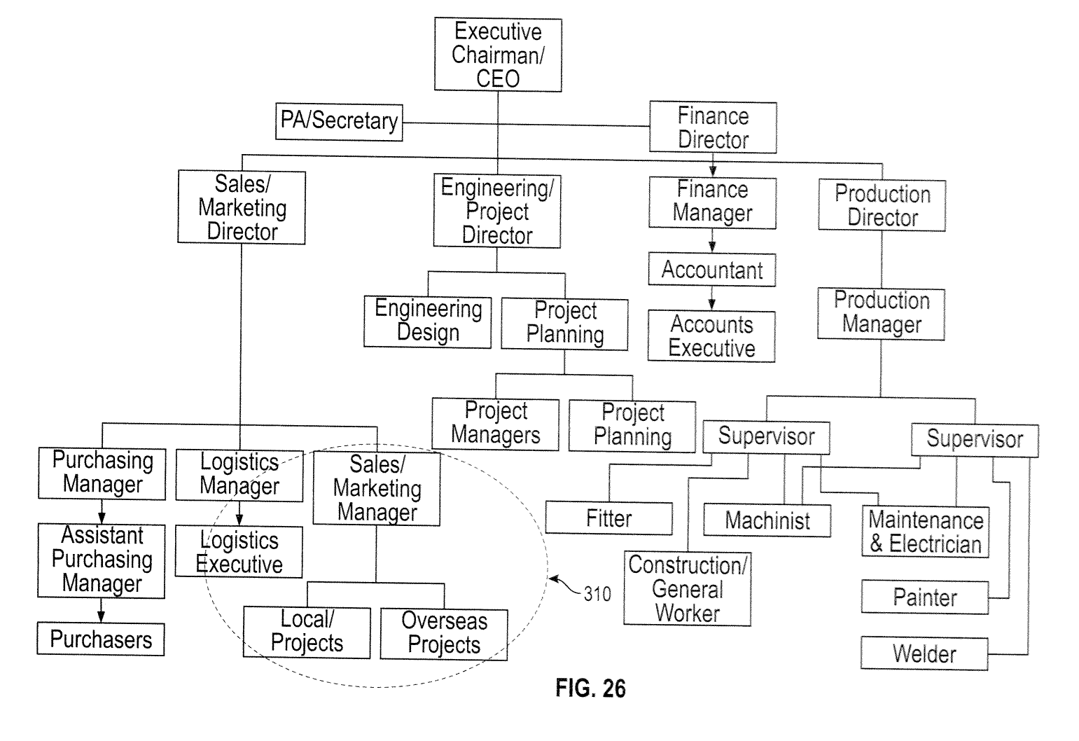

Pictorially, the identified improvement area of business process management 304 is illustrated in FIG. 23 which is the activity map 210 illustrated at the functional level 212 of FIG. 17. The production process 306 which should be improved is illustrated in FIG. 24 and the project resource planning and scheduling 308 which should be improved is illustrated in FIG. 25. As for sales and marketing 310, this is much easier to be illustrated as part of the organizational chart of FIG. 14 and FIG. 26 shows this. It should be appreciated that these pictorial representations are useful but not necessary.

3.2 Identify Activities Input Resources and Outputs Of Improvement Areas

This section identifies and assesses the different activities, input resources, and outputs for each improvement area 302 and these may be obtained from the activity map from Stage 2. Each activity has its respective input resources (labour, material, energy and capital) and outputs. Monetary term is used as the base value for easy comparison and this helps the company become aware of the input expenses incurred for the output obtained for each improvement area.

The representatives begin by reviewing worksheet 3a of FIG. 22 on improvement areas 302 and for each improvement area, identify the corresponding activities, input resources, and outputs which are currently performed. Next is to record the type of activities and quantity values for the input resources and outputs for each improvement area and this is further elaborated below.

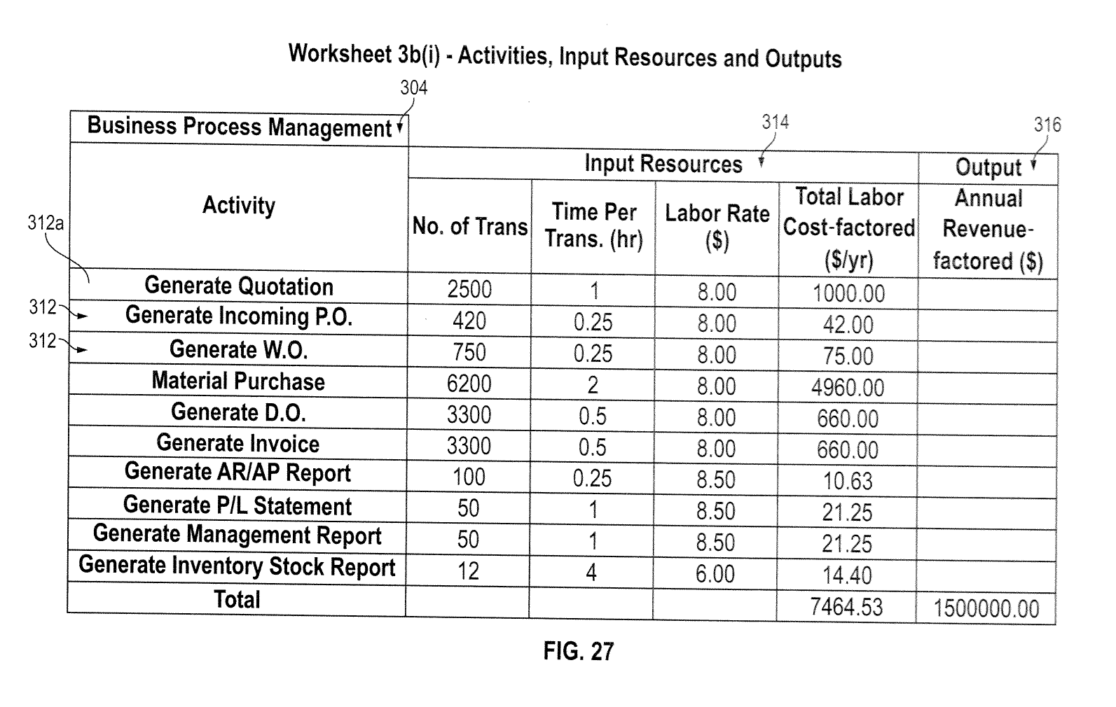

For the improvement area “business process management” 304, identified activities 312, input resources 314 and output 316 being performed by this functional group of Company A are illustrated in worksheet 3b(i) of FIG. 27. For example, to generate a quotation 312a, time per transaction is 1 hour with the total labour cost per year being $1000.

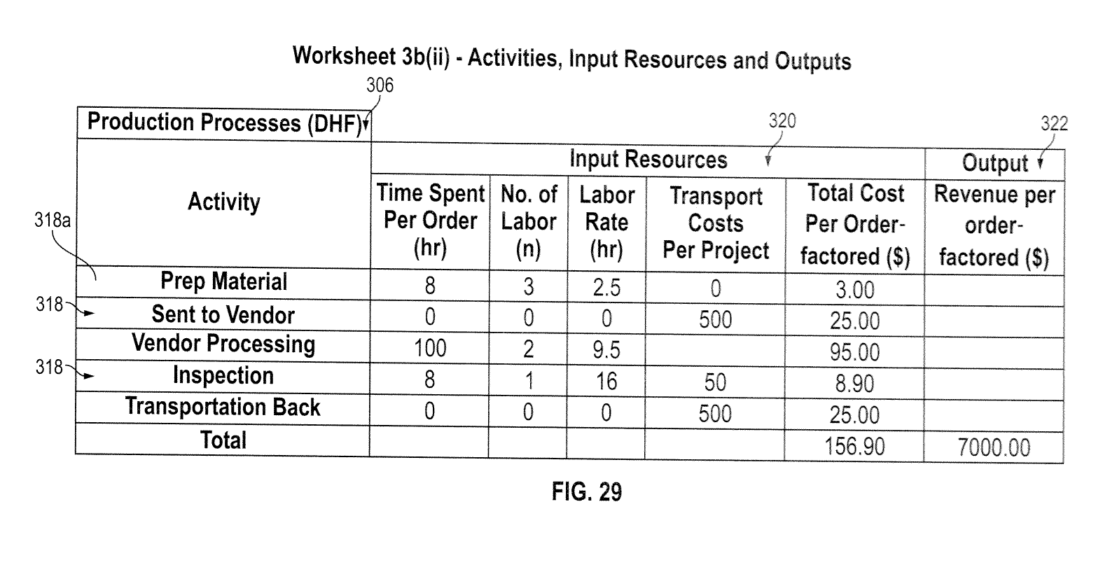

In FIG. 29, the representatives list down activities 318, input resources 320 and output 322 in worksheet 3b(ii) of FIG. 29 for the “Production process”. For example, to prepare material 318a, the time spent per order is 8 hours with 3 personnnel (i.e. No. of Labour) needed with the total cost per order being $3.00 and the output 322 is the revenue per order.

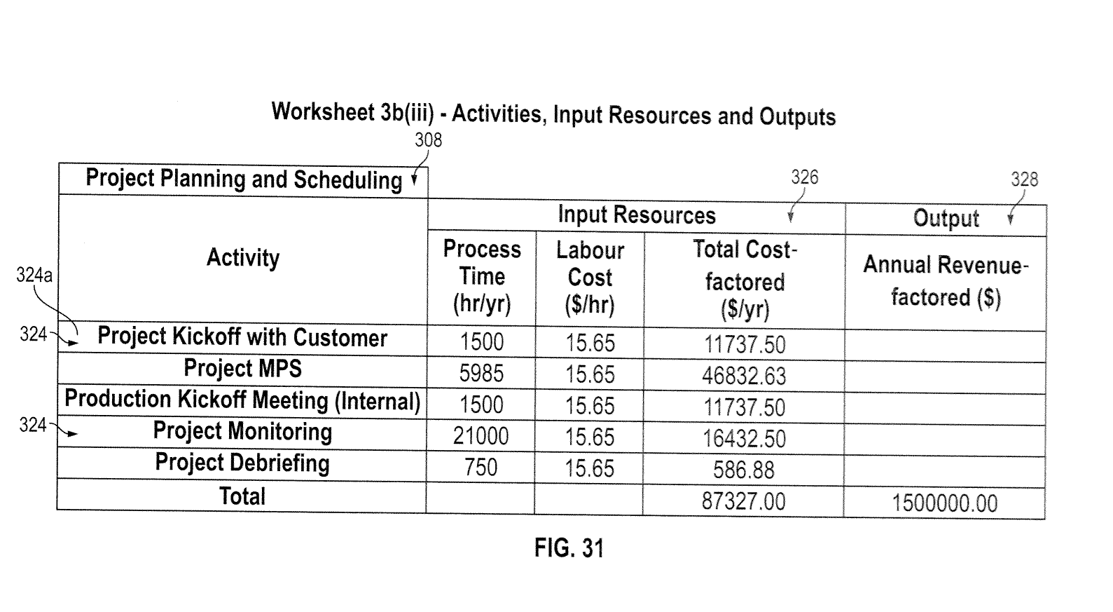

In FIG. 31, the representatives list down activities 324, input resources 326 and output 328 in worksheet 3b(iii) of FIG. 31 for the “Project planning and scheduling”. For example, to prepare project kickoff with customer 324a, the process time and labour cost are 1500 hours/year and $15.65/hour with the output 328 is “Annual Revenue”.

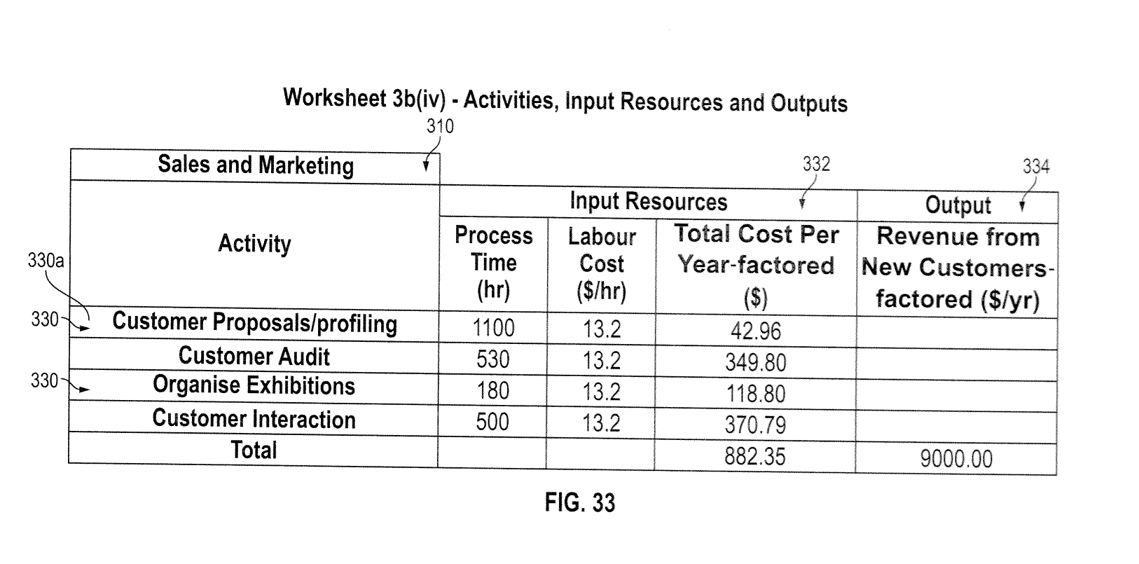

Worksheet 3b(iv) of FIG. 33 is for recording activities 330. input resources 332 and output 334 for “Sales and marketing” 310. In this example, the activities include customer proposals/profiling which incurs total cost per year of $42.96 with the output 334 being revenue from new customers.

3.3 Assess Current Productivity of Improvement Areas

The previous sections have identified the improvement areas as well as the corresponding activities, input resources, and outputs for each of the improvement areas. This section provides an assessment or calculation of the current productivity for each of the identified improvement areas.

Generally, the improvement areas in worksheets 3b(i), 3b(ii), 3b(iii) and 3b(iv) are reviewed and the corresponding information on activities, quantity values for input resources and outputs are extracted to obtain the current productivity.

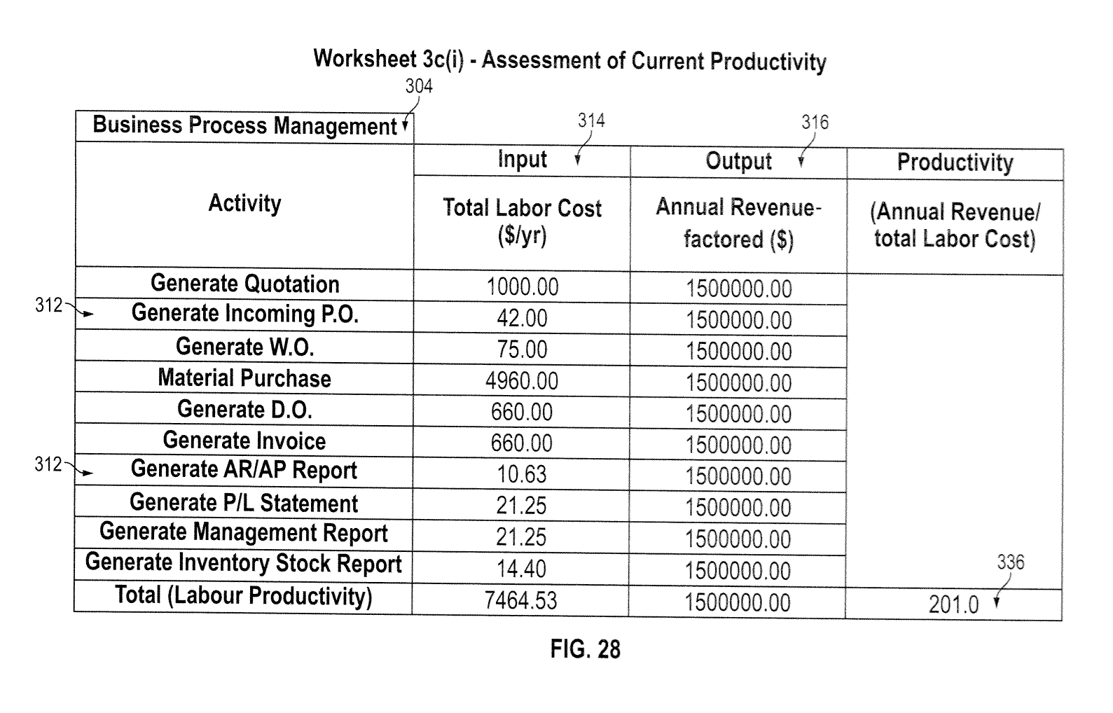

Using the example of the Business process management 306, the input activities 312, total cost of the input resources 314 and output 316 are mapped to worksheet 3c(i) of FIG. 28 for calculating the current productivity 336 of the Business process management improvement area. In this example, the current productivity 336 is calculated based on the total labour cost and the annual revenue as the output 316 which yields a productivity of 201.0. This is also called labour productivity 336.

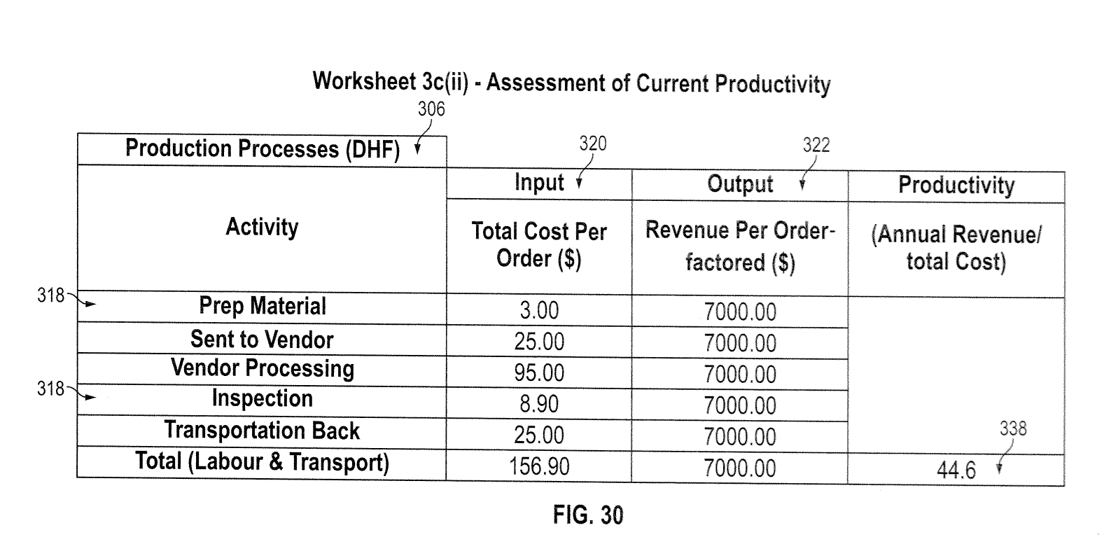

For the next improvement area “Production process” 306, likewise, the activities 318, total cost for t he input resources 320 and the output are mapped to worksheet 3c(ii) of FIG. 30 and the current productivity 338 for this area is calculated to be 44.6. This is also known as labour and transportation productivity 338.

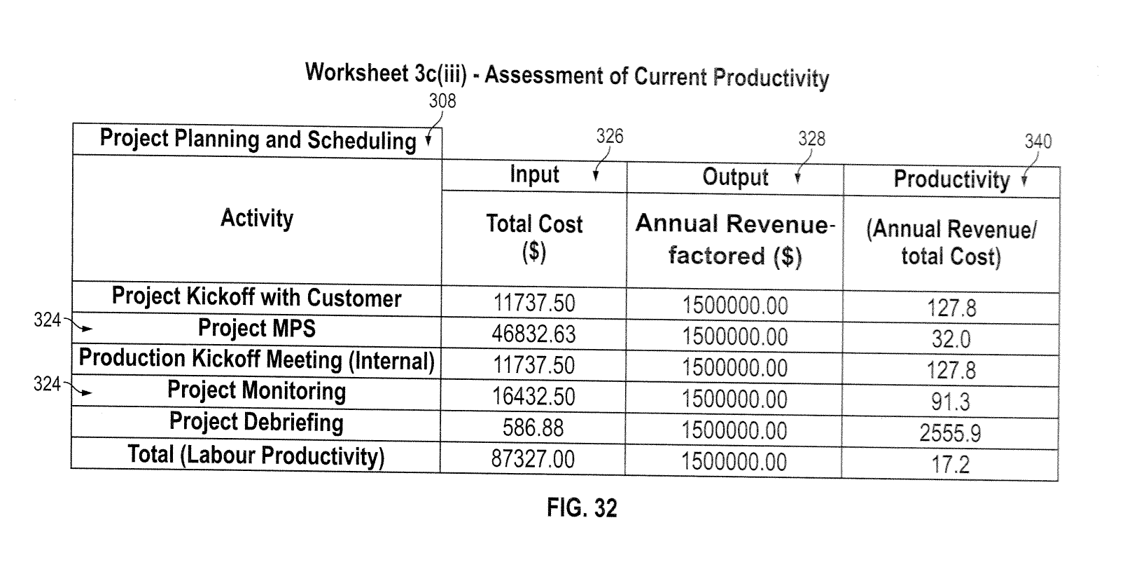

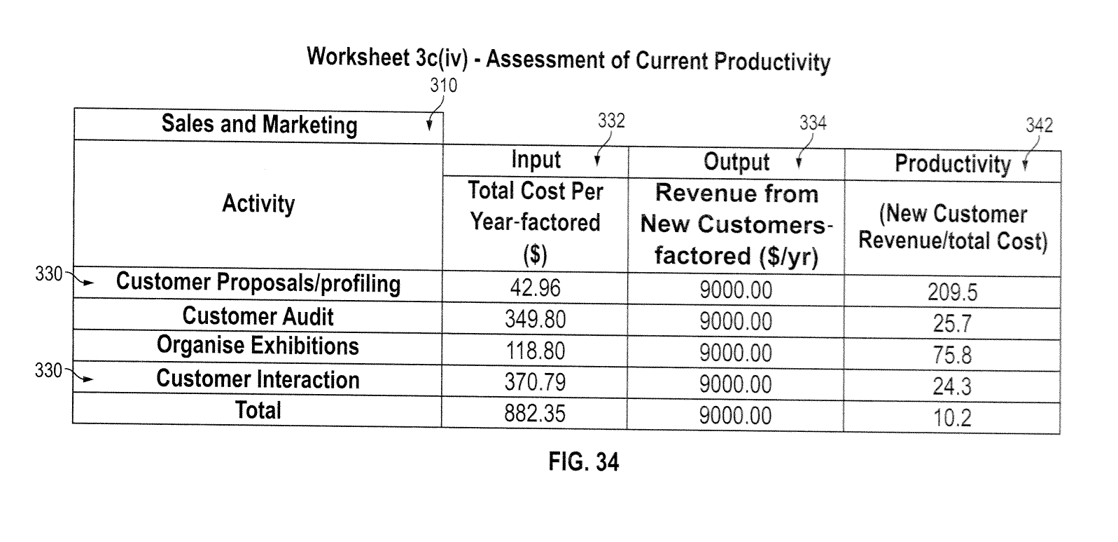

Similarly, using worksheets 3c(iii) and 3c(iv) of FIGS. 32 and 34, the current productivities 340,342 for Project planning and scheduling 308 and Sales and marketing 310 are also calculated and recorded.

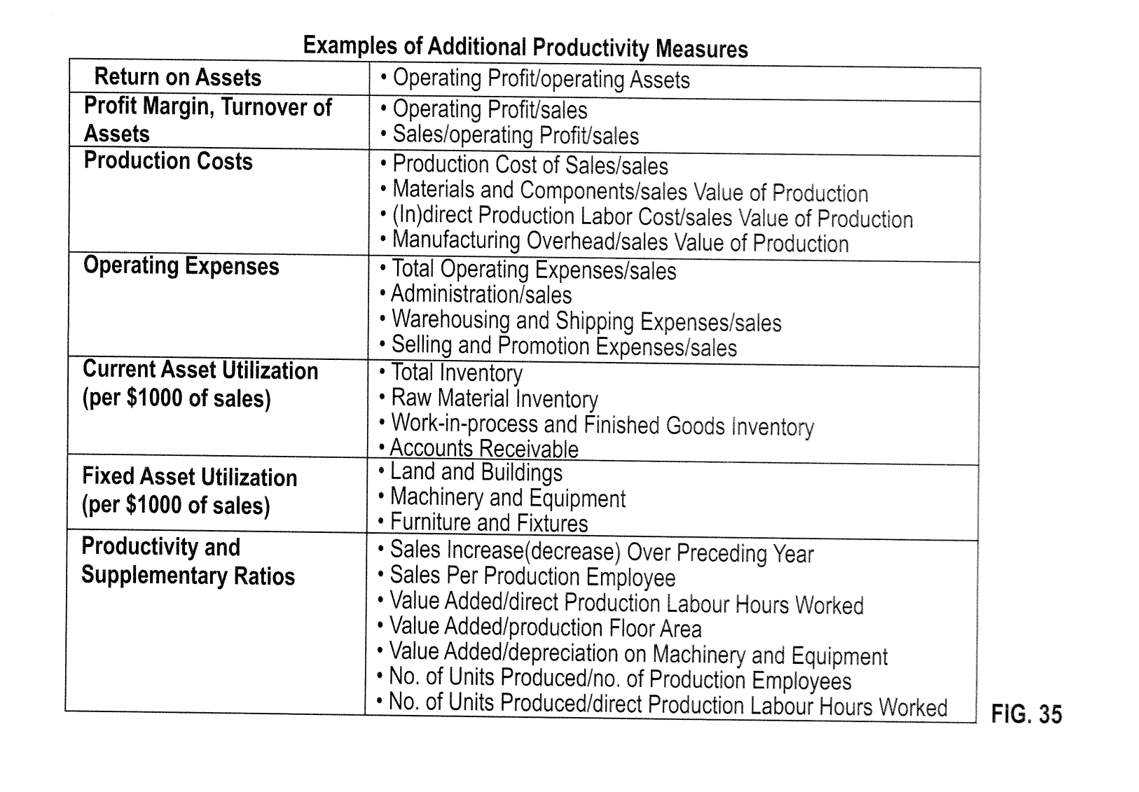

It should be appreciated that other productivity index or measures may be used for example, in terms of Labour Productivity, Material Productivity, Energy Productivity, Capital Productivity, and Total Productivity. Examples of the various parameters used for measuring productivity are provided in FIG. 35.

At the end of Stage 3, the current productivity of each improvement area is derived.

Stage 4 (400): Generate and Prioritise Initiatives

An objective of Stage 4 is to generate initiatives based on the improvement areas and current productivity identified in Stage 3. Following the new initiatives, the future productivity of each improvement area is assessed and the initiatives prioritized. There may be many criteria for prioritization of the initiatives, and one of which is based on the largest productivity gain for a given initiative.

4.1 Generate Initiatives

The previous sections have identified the business objectives 158, improvement areas 302 and the respective current productivity 336. 338, 340, 342 of each of the improvement areas. This section provides analysis, solicitation and generation of initiatives to meet the business objectives and improve productivity.

The representatives start by reviewing worksheet 3a of FIG. 22 to identify the Improvement areas and related business objectives (and even measures and targets as identified in worksheet 1i). For each of the improvement areas, the representatives brainstorm to generate or identify initiatives or new activities for the improvement areas so that the business objectives can be met and there is a corresponding improvement in productivity.

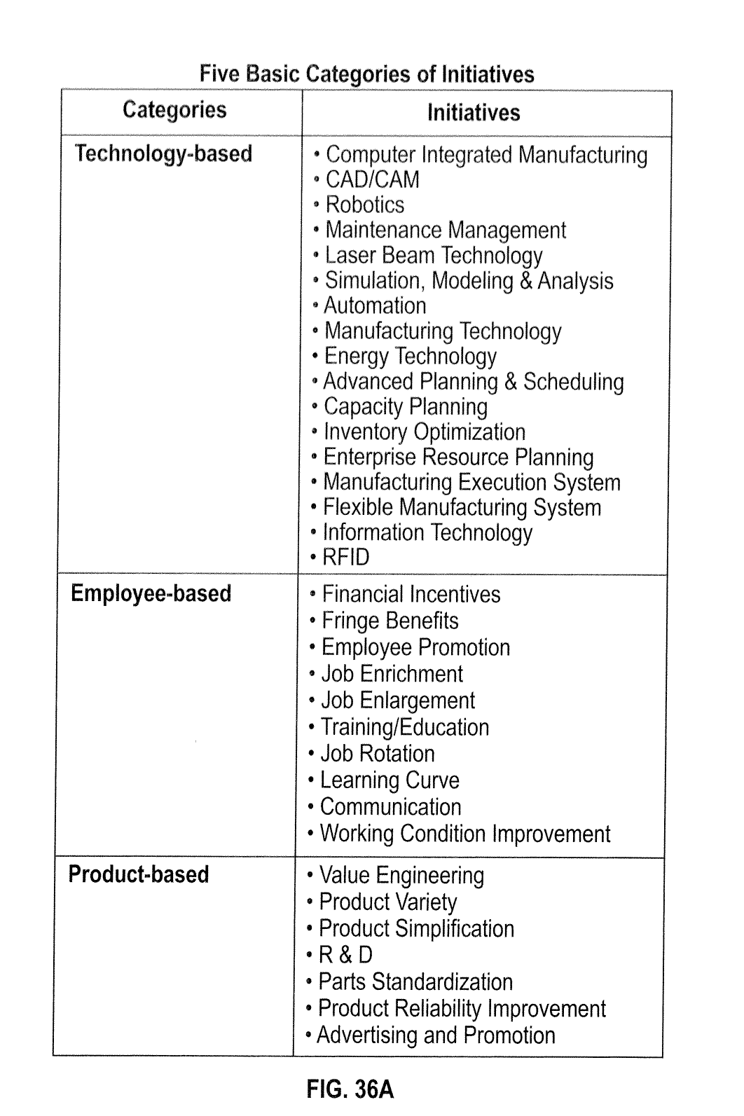

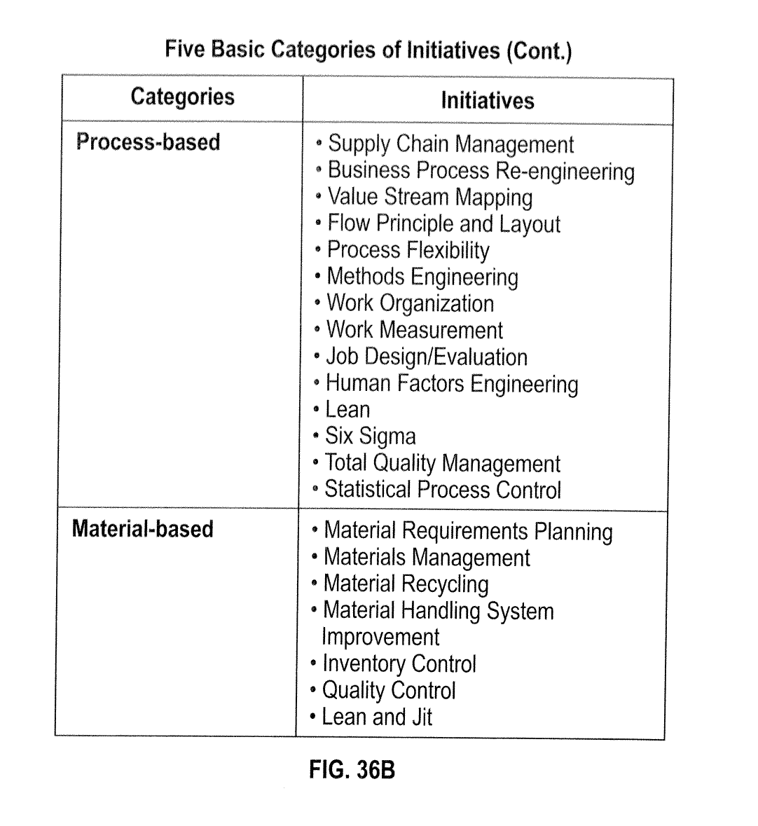

FIGS. 36a and 36b are tables of some examples if possible initiatives for consideration by the representatives. These exemplary initiates are categorized into five basic types of initiatives, namely technology-based, employee-based, product-based, process-based, and material-based.

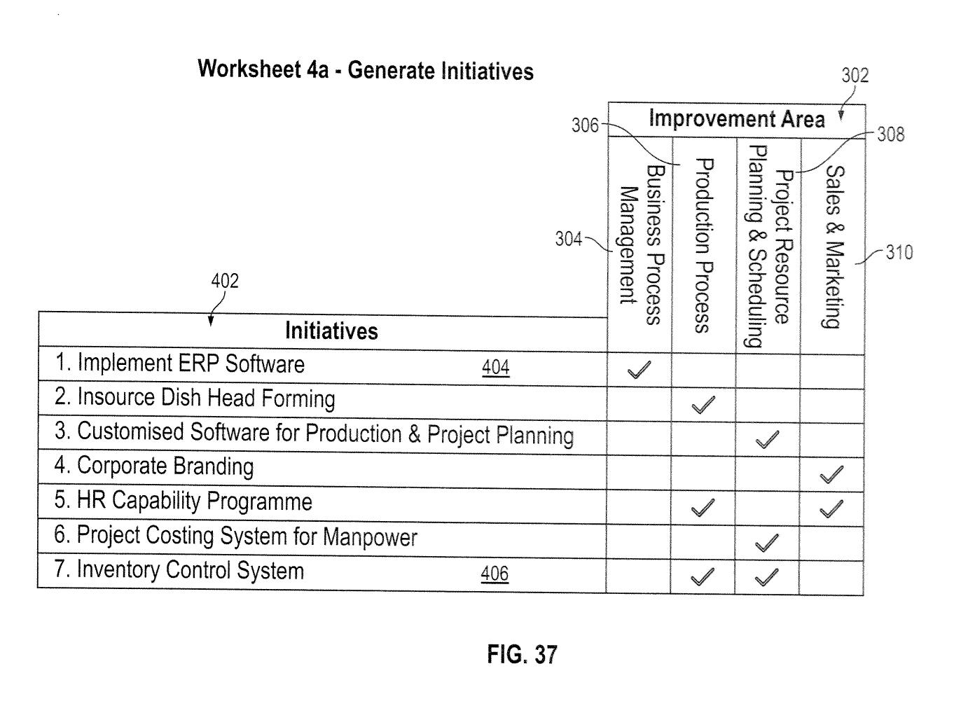

In the case of Company A with the identified improvement areas as “Business process management” 304, “Production process” 306, “Project resource planning and scheduling” 308 and “Sales and marketing” 310, the initiatives 402 identified by the representatives are recorded on worksheet 4a of FIG. 37. For example, initiative “Implement ERP software” 404 has been suggested to address the area which needs improving “Business process management” 304. On the hand, an “Inventory control system” 406 has been suggested to improve the “Production process” 306 and “Project resource planning and scheduling” 308.

With the initiatives 402 identified for each improvement area, the next step is to calculate the expected productivity if these initiatives are implemented.

4.2 Assess future productivity of improvement areas

The previous sections have identified the improvement areas 302, the current productivity 336, 338, 340, 342 of the improvement areas, as well as generated the initiatives for 402 each of the improvement areas. This section provides an assessment of the future productivity for each of the initiative generated for the improvement areas.

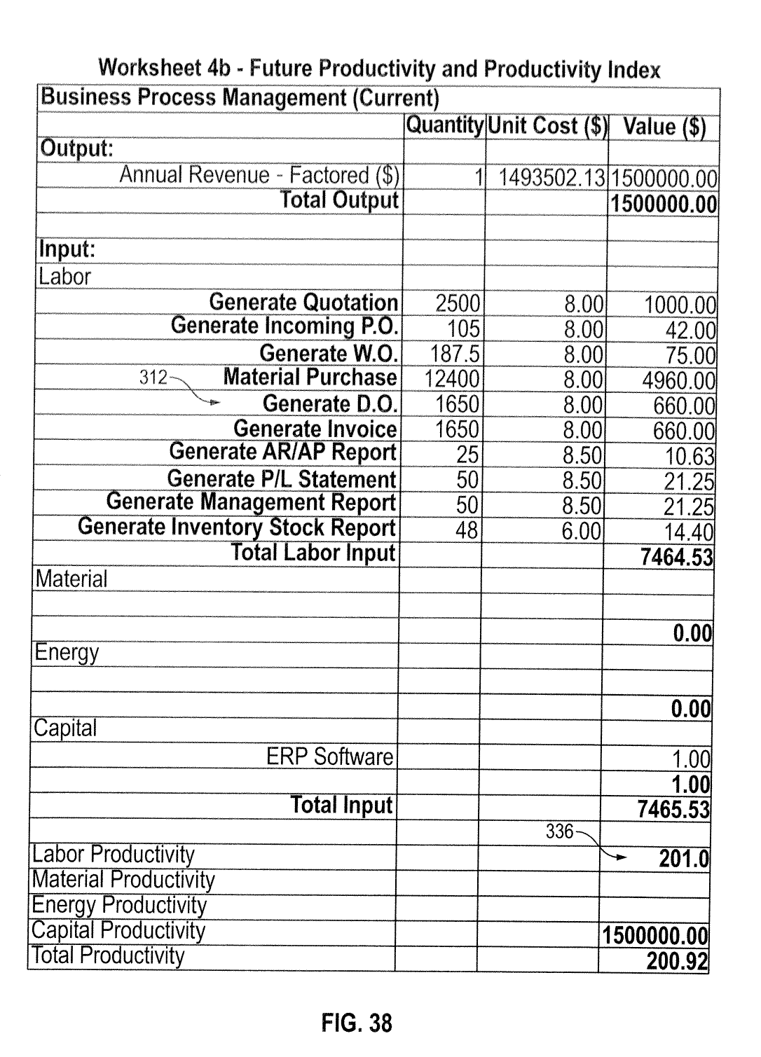

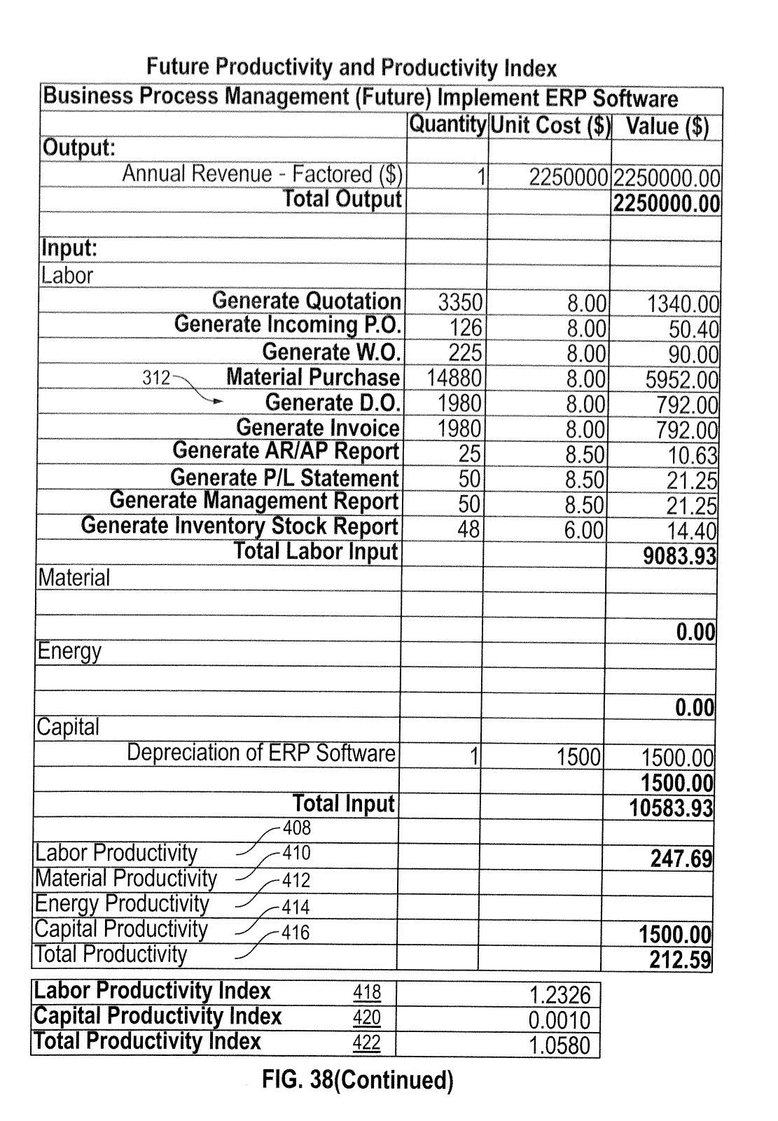

The comparison of the future productivity is with the current productivity 336,338,340,342 obtained at Stage 3. Using the example of “Business process management” 304, the details of FIG. 28 are populated on worksheet 4b of FIG. 38 for comparison with the “labour productivity” 201 indicated as 201.0. Next, the future productivity of the same activities 312 are assessed based on the initiative of the EPR software being implemented and the future productivity is derived in terms of future Labour productivity 408, future Material productivity 410, future Energy Productivity 412, future Capital Productivity 414 and future Total Productivity 416. In this embodiment, the future labour productivity is calculated to be as 247.69 if ERP is implemented. The future Capital Productivity is calculated to be 1500.00 whereas the total productivity is assessed to be 212.59.

Next, the future productivity values are normalized with the current productivity to derive Labour productivity index 418, Capital Productivity Index 420 and the Total Productivity Index 1.0580.

The calculations in worksheet 4b are repeated for each of the initiatives generated for the improvement area in Worksheet 4a by estimating the changes in quantity and price values in the future period columns for each of the activities, input resources and outputs in Worksheet 4b to assess future productivity for each initiative.

4.3 Prioritise Initiatives

This section provides a ranking of the initiatives 402 based on the productivity indexes of the improvement areas 302. Based on this ranking and the importance of the business objectives, the initiatives are prioritized.

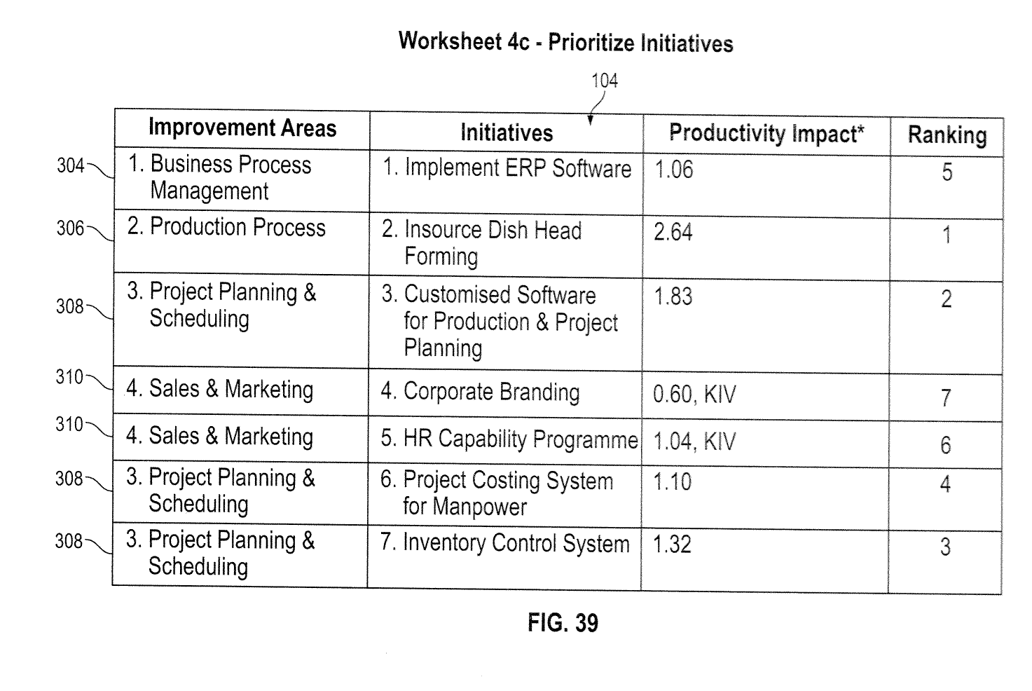

The productivity impact and the corresponding initiatives and for the various improvement areas 302 are shown in worksheet 4c of FIG. 39 to determine which one has the highest impact or productivity gain with “1” being the highest ranking to correspond to the highest productivity index. In this example, implementing the initiative “In-source dish head forming” for Production process achieves the greatest productivity impact with a ranking of 1, whereas implementing the HR capability programme is expected to achieve the poorest productivity impact for improving Sales and marketing and thus, this is ranked last. “In-source” means to do activities which were outsourced in-house or by themselves.

The representatives should discuss the importance of the business objectives, and do a prioritization of all the initiatives in view of the ranking based on the productivity impact.

Stage 5 (500): Develop Action Plan

An objective of Stage 5 is to develop a detailed action plan for the list of prioritized initiatives that are aligned to the business objectives. The responsibilities, resources required, timescale, and clear milestones for each of the initiatives are set at this Stage.

5.1 Assign Responsibilities and Estimate Budget Required

This section assigns responsibilities and resources required for each of the initiatives identified in Stage 4, in particular the prioritized initiatives which Company A decides to implement.

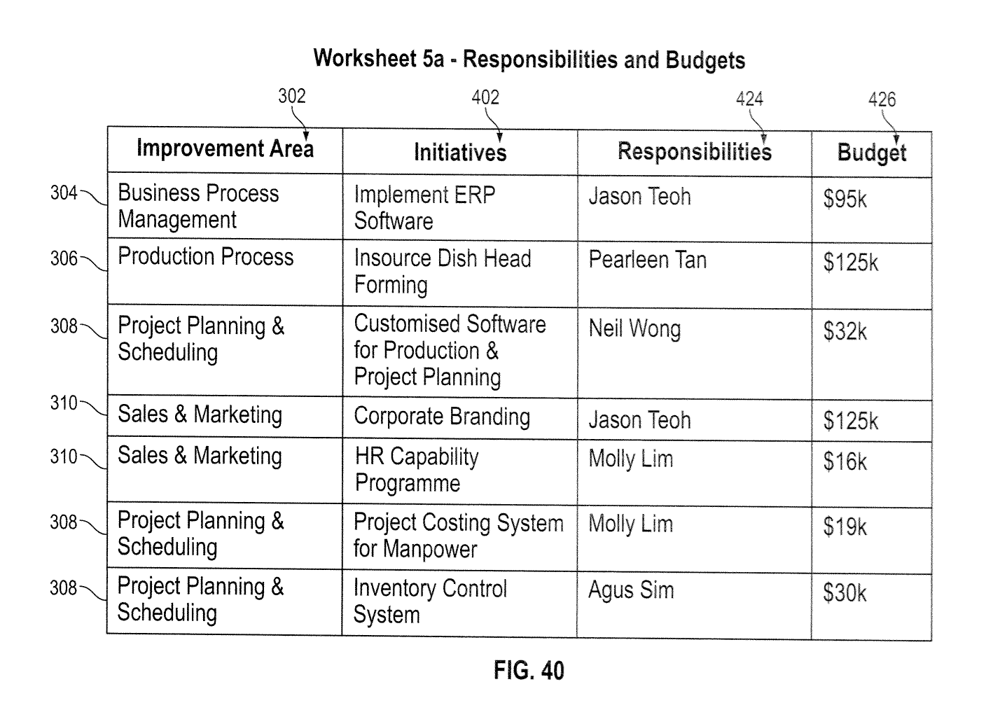

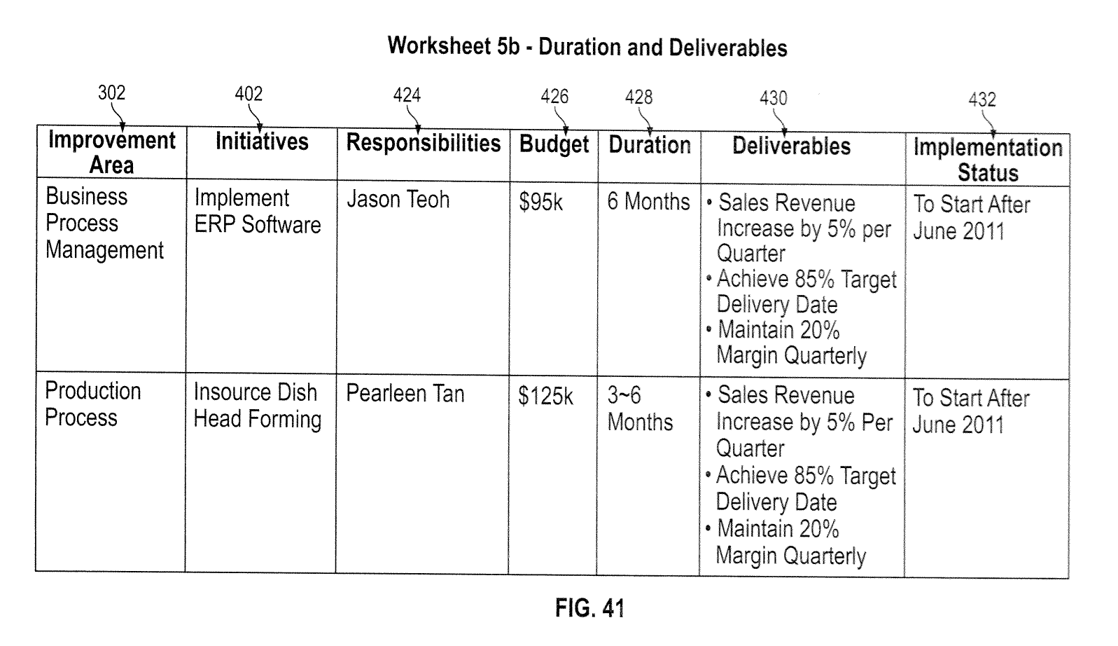

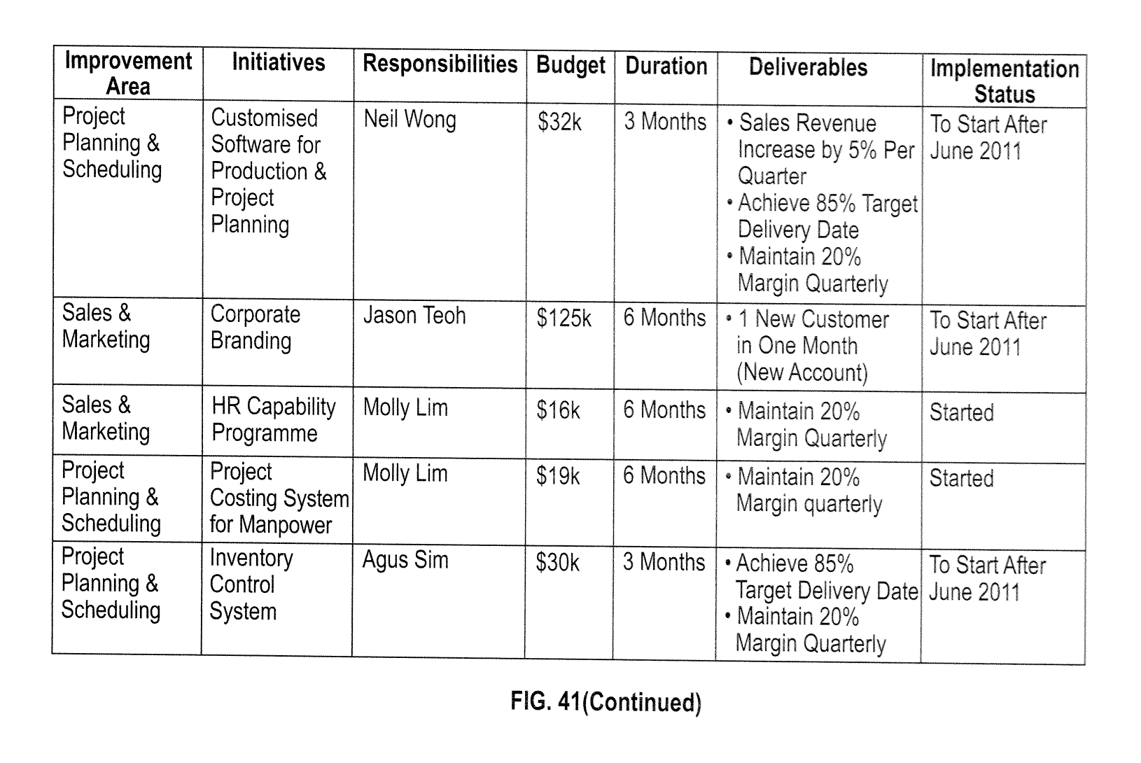

In this section, the representatives brainstorm and decide who is assigned (from the functional groups identified earlier) with the responsibility of implementing the respective initiatives and these are recorded in worksheet 5a of FIG. 40 under Responsibilities 424. Further, the representatives need to obtain the cost and assign a budget 426 to implement each of the initiatives as shown in FIG. 40. For example, in this embodiment, a budget of $95K is being allocated to implement the ERP software initiative to improve on the Business process management 304.

It should be mentioned that the person assigned the responsibility in worksheet 5a is considered a “champion” responsible for the initiative. The champion needs to be a fairly senior manager within the company who is charged with making decisions and ensuring the successful implementation of the initiatives.

A project leader and resources required may also need to be identified. The project leader would preferably be appointed by the champion to manage the successful implementation of corresponding initiative.

5.2 Establish Duration and Deliverables

This section establishes the duration for the implementation for each of the initiatives and deliverables to ensure the success of the initiatives.

With the champion 424 and budget 426 allocated, the next step is for the representatives to establish duration 428 and deliverables 430 for implementing each of the initiatives 402. For each of the initiative, the duration 428 is established with start and end dates agreed in the discussion and this is shown under implementation status 432.

Besides the duration, the deliverables 430 are also identified and agreed in the discussion to ensure the successful implementation of the initiatives. In this respect, the deliverables are based on the quantifiable targets 162 defined earlier in Stage 1 and recorded in worksheet 1i of FIG. 12. In this way, the deliverables 430 are aligned or checked back to the business objectives and the quantifiable targets 162.

As it can be appreciated, the OmniMethodology™ 1000 provides a systematic process to guide operations management innovators in championing the use of operations management techniques to help them to analyze their operations in order to improve productivity and sustain a competitive advantage. Productivity is a very important measure in manufacturing operations, besides turnover and profit, as it provides insight into the efficiency and effectiveness of operations. The purpose of this methodology is to provide an integrated and holistic approach to determine a company's business competitive strategy, gaps and performance targets: identify the operations improvement areas and measure the productivity: generate operations improvement initiatives to achieve productivity gain; and finally to develop the implementation action plan.

As operations management is a continuous improvement process and must be aligned to a company's competitive strategy, this method 1000 helps the operations management innovators to systematically use the methodology to continuously improve the efficiency and effectiveness of their operations year after year.

The described embodiment is not to be construed as limitative. In the described embodiment, reference is made to a company but it should be appreciated that the method 1000 is also applicable for other types of businesses. Further, certain elements of the stages 100,200,300,400,500 may be performed earlier or later depending on the requirements. For example, it may be preferred to review the company's organization chart at stage 1 rather than stage 2 so that from the onset, the users already have an idea of the company's organization.

At stage 1, the company's business strategy us identified using sets of 30 questions but it should be appreciated that the number of questions may be varied accordingly. Also, the questions to identify the company's current competitive strategy may not be the same as the questions to identify the company's future competitive strategy.

Also, Stages 1 to 5 may not be implemented in sequence and it is envisaged that some stages might be implemented in parallel with another stage. Also, stage 5 may not be necessary if the action plans are to be developed later.

Having now fully described the invention, it should be apparent to one of ordinary skill in the art that many modifications can be made hereto without departing from the scope as claimed.

1. An operations management method for a business comprising
(i) determining at least one competitive gap of the business from a performance review of the business;
(ii) identifying at least one business objective to address the at least one competitive gap;
(ii) identifying at least one functional group for meeting the at least one business objective;
(iii) generating an activity diagram to define work process of the business based on the at least one functional group;
(iv) identifying at least one improvement area based on the generated activity diagram and in relation to the at least one business objective;
(v) calculating current productivity of activities being performed at the at least one improvement area;
(vi) identifying an initiative to improve the at least one improvement area and which is expected to achieve a better productivity than the calculated current productivity.

2. An operations management method according to claim 1, wherein (i) the performance review comprises deriving business background information from analyzing products, customers and competitors of the business.

3. An operations management method according to claim 1, wherein (i) the performance review further comprises determining a current competitive strategy and a future competitive strategy for the business.

4. An operations management method according to claim 3, wherein the current and future competitive strategies is derived based on answers to a same set of questions.

5. An operations management method according to claim 4, wherein the same set of questions includes subsets of questions with each subset of questions being associated with respective business competence of the business.

6. An operations management method according to claim 5, further including, to determine the current competitive strategy, assigning a numeral score to each question, and mapping the scores for each question to the associated business competence and adding up the associated scores belonging to the same business competence to derive respective current competitive strategy scores.

7. An operations management method according to claim 5, further including, to determine the future competitive strategy, assigning a numerical score to each question, and mapping the scores for each question to the associated business competence and adding up the associated scores belong to the same business competence to derive respective future competitive strategy scores.

8. An operations management method according to claim 5, wherein the business competence is selected from the group comprising the business' customer intimacy, operational excellence and product leadership.

9. An operations management method according to claim 3, wherein (i) the competitive gap is identified from the current and future competitive strategies.

10. An operations management method according to claim 1, wherein (ii) further includes identifying a quantifiable target for the at least one business objective.

11. An operations management method according to claim 10, further including identifying a performance measure to determine if the quantifiable target is achieved.

12. An operations management method according to claim 1, further comprising analysing the business' organizational structure.

13. An operations management method according to claim 12, wherein the at least one functional group is identified from the organization structure.

14. An operations management method according to claim 1, wherein the activity diagram is generated using Value Stream Mapping (VSM) method.

15. An operations management method according to claim 1, wherein the work process include information and/or data flow of the business.

16. An operations management method according to claim 1, further comprising identifying activities, input resources and output of the at least one improvement area.

17. An operations management method according to claim 1, wherein there is a plurality of improvement areas identified, and the method includes calculating current productivity of activities being performed at each of the improvement areas.

18. An operations management method according to claim 17, wherein each improvement area is associated with respective initiative, and (vii) further comprises calculating expected productivity of each improvement area based on the associated initiative.

19. An operations management method according to claim 18, further includes calculating productivity impact of each improvement area from comparison between respective expected productivity and the current productivity.

20. An operations management method according to claim 19, further comprising ranking each improvement area and associated initiative based on the calculated productivity impact.

21. An operations management method according to claim 18, wherein the current productivity and expected productivity is selected from the group consisting of labour productivity, material productivity, energy productivity, capital productivity.

22. An operations management method according to claim 1, further comprising developing an action plan to implement the initiative.

23. An operations management method according to claim 22, further comprising assigning the initiative to a responsible person for implementing the initiative and allocating a budget for implementing the initiative.

24. An operations management method according to claim 22, further comprising setting a duration for completing the initiative.

25. An operations management method according to claim 22, further comprising assigning a quantifiable target to be achieved by implementing the initiative, the quantifiable target being aligned to the at least one business objective.
